(19) United States
(12) Patent Application Publication
(10) Pub. No.: US 2023/0246700 A1
(43) Pub. Date: Aug. 3, 2023

(54) METHOD AND DEVICE FOR BEAM SELECTION

(71) Applicant: Samsung Electronics Co., Ltd., Suwon-si (KR)

(72) Inventors: Hongchao CHEN, Beijing (CN); Yi ZHAO, Beijing (CN); Xiaohui LIANG, Beijing (CN); Zhe ZHENG, Beijing (CN); Yupu LIU, Beijing (CN); Baozhi ZHANG, Beijing (CN)

(21) Appl. No.: 18/295,585

(22) Filed: Apr. 4, 2023

Related U.S. Application Data
(63) Continuation of application No. PCT/KR2022/013527, filed on Sep. 8, 2022.

(30) Foreign Application Priority Data
Sep. 10, 2021 (CN) 202111064315.9

(51) Int. Cl. H04B 7/08; H04B 17/318

(52) U.S. Cl. CPC H04B 7/088; H04B 17/328

(57) ABSTRACT

The disclosure relates to a 5^{th} generation (5G) or 6^{th} generation (6G) communication system for supporting a higher data transmission rate. The disclosure relates to the field of communication. A method and device for beam selection are provided. The method for beam selection includes acquiring network related information and/or user equipment (UE) related information for the beam selection, determining at least one first candidate beam corresponding to the UE among beams of a base station based on the acquired information, and determining a serving beam of the UE based on the determined at least one first candidate beam.

### CROSS-REFERENCE TO RELATED APPLICATION(S)

This application is a continuation application, claiming priority under § 365(c), of an International application No. PCT/KR2022/013527, filed on Sep. 8, 2022, which is based on and claims the benefit of a Chinese patent application number 202111064315.9, filed on Sep. 10, 2021, in the Chinese Intellectual Property Office, the disclosure of which is incorporated by reference herein in its entirety.

### TECHNICAL FIELD OF THE DISCLOSURE

The disclosure relates to the field of wireless communication. More particularly, the disclosure relates to a scheme for improving the system throughput of an above 6 GHz (A6G) distributed Multi-input Multi-output (MIMO) system by means of beam selection in a 5th generation (5G) wireless systems network.

### BACKGROUND

5G mobile communication technologies define broad frequency bands such that high transmission rates and new services are possible, and can be implemented not only in “Sub 6 GHz” bands such as 3.5 GHz, but also in “Above 6 GHz” bands referred to as mmWave including 28 GHz and 39 GHz. In addition, it has been considered to implement 6th generation (6G) mobile communication technologies (referred to as Beyond 5G systems) in terahertz (THz) bands (for example, 95 GHz to 3THz bands) in order to accomplish transmission rates fifty times faster than 5G mobile communication technologies and ultra-low latencies one-tenth of 5G mobile communication technologies.

At the beginning of the development of 5G mobile communication technologies, in order to support services and to satisfy performance requirements in connection with enhanced Mobile BroadBand (eMBB), Ultra Reliable Low Latency Communications (URLLC), and massive Machine-Type Communications (mMTC), there has been ongoing standardization regarding beamforming and massive MIMO for mitigating radio-wave path loss and increasing radio-wave transmission distances in mmWave, supporting numerologies (for example, operating multiple subcarrier spacings) for efficiently utilizing mmWave resources and dynamic operation of slot formats, initial access technologies for supporting multi-beam transmission and broadbands, definition and operation of BandWidth Part (BWP), new channel coding methods such as a Low Density Parity Check (LDPC) code for large amount of data transmission and a polar code for highly reliable transmission of control information, L2 pre-processing, and network slicing for providing a dedicated network specialized to a specific service.

Currently, there are ongoing discussions regarding improvement and performance enhancement of initial 5G mobile communication technologies in view of services to be supported by 5G mobile communication technologies, and there has been physical layer standardization regarding technologies such as Vehicle-to-everything (V2X) for aiding driving determination by autonomous vehicles based on information regarding positions and states of vehicles transmitted by the vehicles and for enhancing user convenience, New Radio Unlicensed (NR-U) aimed at system operations conforming to various regulation-related requirements in unlicensed bands, NR user equipment (UE) Power Saving, Non-Terrestrial Network (NTN) which is UE-satellite direct communication for providing coverage in an area in which communication with terrestrial networks is unavailable, and positioning.

Moreover, there has been ongoing standardization in air interface architecture/protocol regarding technologies such as Industrial Internet of Things (IIoT) for supporting new services through interworking and convergence with other industries, Integrated Access and Backhaul (IAB) for providing a node for network service area expansion by supporting a wireless backhaul link and an access link in an integrated manner, mobility enhancement including conditional handover and Dual Active Protocol Stack (DAPS) handover, and two-step random access for simplifying random access procedures (2-step RACH for NR). There also has been ongoing standardization in system architecture/service regarding a 5G baseline architecture (for example, service based architecture or service based interface) for combining Network Functions Virtualization (NFV) and Software-Defined Networking (SDN) technologies, and Mobile Edge Computing (MEC) for receiving services based on UE positions.

As 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with eXtended Reality (XR) for efficiently supporting Augmented Reality (AR), Virtual Reality (VR), Mixed Reality (MR) and the like, 5G performance improvement and complexity reduction by utilizing Artificial Intelligence (AI) and Machine Learning (ML), AI service support, metaverse service support, and drone communication.

Furthermore, such development of 5G mobile communication systems will serve as a basis for developing not only new waveforms for providing coverage in terahertz bands of 6G mobile communication technologies, multi-antenna transmission technologies such as Full Dimensional MIMO (FD-MIMO), array antennas and large-scale antennas, metamaterial-based lenses and antennas for improving coverage of terahertz band signals, high-dimensional space multiplexing technology using Orbital Angular Momentum (OAM), and Reconfigurable Intelligent Surface (RIS), but also full-duplex technology for increasing frequency efficiency of 6G mobile communication technologies and improving system networks, AI-based communication technology for implementing system optimization by utilizing satellites and Artificial Intelligence (AI) from the design stage and internalizing end-to-end AI support functions, and next-generation distributed computing technology for implementing services at levels of complexity exceeding the limit of UE operation capability by utilizing ultra-high-performance communication and computing resources.

5G needs to support high-capacity indoor service transmission. It is estimated that a traffic with an average of 45 GB will be produced per smartphone per month by 2025, and 80% of 5G service of operators will be indoor service. Compared with below 6 GHz (B6G), A6G can provide a larger transmission bandwidth. In addition, the distributed massive MIMO (mMIMO), a large-scale antenna technology is an important way to deploy a mMIMO system in an indoor scenario, and is also the key technology to achieve 5G high-capacity indoor data transmission. However, in an A6G distributed mMIMO system, an area is often covered by multiple beams of different antenna panels, so effective beam selection is required to be performed in order to achieve a good system performance. FIG. 1 is a schematic diagram of an A6G distributed MIMO system. Beam selection is a big challenge to implement the A6G distributed mMIMO technology.

In the existing B6G distributed mMIMO system, it is not necessary for the base station to make beam selection. The beam selection algorithm of an A6G centralized mMIMO system is relatively simple, but in an A6G distributed mMIMO system, an area is often covered by multiple beams of different antenna panels, so the simple beam selection algorithm of the A6G centralized mMIMO system cannot be used in the A6G distributed mMIMO system.

The above information is presented as background information only to assist with an understanding of the disclosure. No determination has been made, and no assertion is made, as to whether any of the above might be applicable as prior art with regard to the disclosure.

### SUMMARY

The scheme provided by the application enables a 5th generation (5G) base station to quickly and dynamically select a suitable serving beam for each UE in an indoor distributed massive Multi-input Multi-output (mMIMO) system.

Aspects of the disclosure are to address at least the above-mentioned problems and/or disadvantages and to provide at least the advantages described below. Accordingly, an aspect of the disclosure is to provide an apparatus and method for —.

Additional aspects will be set forth in part in the description which follows and, in part, will be apparent from the description, or may be learned by practice of the presented embodiments.

In accordance with an aspect of the disclosure, a method for beam selection is provided. The method includes acquiring at least one of network related information or user equipment (UE) related information for the beam selection, determining at least one first candidate beam corresponding to the UE among beams of a base station based on the at least one of network related information or UE related information, and determining a serving beam for the UE based on the determined at least one first candidate beam.

In accordance with another aspect of the disclosure, an electronic device for beam selection is provided. The electronic device includes a first circuit for acquiring network related information and/or UE related information for the beam selection, a second circuit for determining at least one first candidate beam corresponding to the UE among beams of a base station based on the acquired information, and a third circuit for determining a serving beam for the UE based on the determined at least one first candidate beam.

With the embodiments of the application, the effects of quickly and dynamically selecting a suitable serving beam for each UE to improve the system throughput can be achieved.

Other aspects, advantages, and salient features of the disclosure will become apparent to those skilled in the art from the following detailed description, which, taken in conjunction with the annexed drawings, discloses various embodiments of the disclosure.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 shows a schematic diagram of an above 6 GHz (A6G) distributed Multi-input Multi-output (MIMO) system according to an embodiment of the disclosure;

FIG. 2 shows a schematic diagram of the inventive concept according to an embodiment of the disclosure;

FIG. 3 shows a flow chart of a beam selection method according to an embodiment of the disclosure;

FIG. 4 shows an explanatory diagram of a beam selection method according to an embodiment of the disclosure;

FIG. 5 shows a schematic diagram of a cooperative beam according to an embodiment of the disclosure;

FIG. 6 shows a schematic diagram of Reference Signal Receiving Power (RSRP) values corresponding to respective beams according to an embodiment of the disclosure;

FIG. 7 shows a schematic diagram of grouping RSRPs based on a non-AI method according to an embodiment of the disclosure;

FIG. 8 shows a schematic diagram of grouping RSRPs based on an AI method according to an embodiment of the disclosure;

FIG. 9 shows a schematic diagram of determining the RSRP range corresponding to a user according to the RSRP of an optimal beam of according to an embodiment of the disclosure;

FIG. 10 shows a schematic diagram of beam status update according to an embodiment of the disclosure;

FIG. 11 shows a flow chart of deciding a serving beam to be generated by a next Generation NodeB (gNB) according to an embodiment of the disclosure;

FIG. 12 shows the main modules affecting interference detection and the flow of their interaction according to an embodiment of the disclosure;

FIG. 13 shows a schematic diagram of an interference beam list according to an embodiment of the disclosure;

FIG. 14 shows a schematic diagram of setting an interference flag according to an embodiment of the disclosure;

FIG. 15 shows a schematic diagram of a user equipment (UE) to be scheduled according to an embodiment of the disclosure;

FIG. 16 shows a schematic diagram of an accuracy detection flow according to an embodiment of the disclosure;

FIG. 17 shows a schematic diagram of the position of the accuracy detection step in the overall flow according to an embodiment of the disclosure;

FIG. 18 shows a flow chart of determining a serving beam to be generated by a gNB according to an embodiment of the disclosure;

FIG. 19 shows a schematic diagram of determining a serving beam to be generated by a gNB according to an embodiment of the disclosure;

FIG. 20 shows a schematic diagram of case S1 according to an embodiment of the disclosure;

FIG. 21 shows a schematic diagram of case S2 according to an embodiment of the disclosure;

FIG. 22 shows a schematic diagram of case S3 according to an embodiment of the disclosure;

FIG. 23 shows a schematic diagram of beam selection according to an embodiment of the disclosure;

FIG. 24 shows a block diagram of a Medium Access Control (MAC) module in a Distributed Unit (DU) of a gNB device according to an embodiment of the disclosure;

FIG. 25 shows a schematic diagram of an A6G centralized MIMO and an A6G distributed MIMO according to an embodiment of the disclosure;

FIG. 26 shows a simulation result according to an embodiment of the disclosure;

FIG. 27 illustrates a block diagram illustrating a structure of a UE according to an embodiment of the disclosure; and

FIG. 28 illustrates a block diagram illustrating a structure of a base station according to an embodiment of the disclosure.

The same reference numerals are used to represent the same elements throughout the drawings.

### DETAILED DESCRIPTION

The following description with reference to the accompanying drawings is provided to assist in a comprehensive understanding of various embodiments of the disclosure as defined by the claims and their equivalents. It includes various specific details to assist in that understanding but these are to be regarded as merely exemplary. Accordingly, those of ordinary skilled in the art will recognize that various changes and modifications of the various embodiments described herein can be made without departing from the scope and spirit of the disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the disclosure. Accordingly, it should be apparent to those skilled in the art that the following description of various embodiments of the disclosure is provided for illustration purpose only and not for the purpose of limiting the disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

The term “include” or “may include” refers to the existence of a corresponding disclosed function, operation or component which can be used in various embodiments of the disclosure and does not limit the existence of one or more additional functions, operations, or components. The terms such as “include” and/or “have” may be construed to denote a certain characteristic, number, step, operation, constituent element, component or a combination thereof, but may not be construed to exclude a possibility of existence of one or more other characteristics, numbers, steps, operations, constituent elements, components or combinations thereof.

The term “or” used in various embodiments of the disclosure includes any or all of combinations of listed terms. For example, the expression “A or B” may include A, may include B, or may include both A and B.

Unless defined otherwise, all terms used herein, which include technical terminologies or scientific terminologies, have the same meaning as that understood by a person skilled in the art to which the disclosure belongs. General terms defined in a dictionary are to be interpreted to have the meanings equal to the contextual meanings in the relevant field of art, and are not to be interpreted in an ideal or excessively formal way unless clearly defined in the disclosure.

In an A6G system, when the transmission signal is blocked and the posture of a UE (or a user, the two can be used interchangeably in the text) changes, because there is no algorithm to quickly re-determine a serving beam for the UE, the data transmission is easy to be interrupted, which will lead to a decrease in throughput of an A6G distributed mMIMO system and deteriorate user experience.

With the embodiments of the application, the system throughput (the amount of data transmitted in unit time) can be improved, and the problem of data transmission interruption due to the transmission signal being blocked and the posture change of the UE can be avoided or reduced.

In order to solve the problems existing in the prior art, the following technical scheme is proposed.

A network-side device (which can also be called a network-side control node) determines a serving beam set for the UE, determines a serving beam for the UE based on information on the serving beam set of the UE, and allocates resources to the UE.

The network-side control node may be a next Generation NodeB (gNB), an open Radio Access Network (ORAN) RAN Intelligent Control (RIC) entity or other entities that can determine the UE serving beam set and allocate resources to the UE. Different functions can be completed by multiple sub-entities, respectively, and the connections between sub-entities can be wired or wireless connections.

The following inventive content is illustrated by an example of a gNB. Note that a gNB can also be called a base station, a data unit, etc. In addition, a gNB can be composed of one entity or multiple entities. When a gNB is composed of multiple entities, each entity can have its corresponding name.

According to an aspect of the disclosure, it provides a method for beam selection, comprising acquiring at least one of network related information or user equipment (UE) related information for the beam selection, determining at least one first candidate beam corresponding to the UE among beams of a base station based on the at least one of network related information or UE related information, and determining a serving beam of the UE based on the determined at least one first candidate beam.

According to an embodiment of the disclosure, the network related information comprises at least one of: the numbers of beam failures in respective beams, a relationship between a beam and an antenna panel, and status information of respective frequency-domain, or time-domain resources in a beam scheduling procedure.

According to an embodiment of the disclosure, the UE related information for the beam selection comprises at least one of: reference signal receiving power (RSRP) information of the beam reported by the UE, negative acknowledgement (NACK) information reported by the UE, and proportional fairness (PF) values corresponding to the UE.

According to an embodiment of the disclosure, determining the at least one first candidate beam corresponding to the UE among the beams of the base station based on the at least one of network related information or UE related information comprises: among respective beams of the base station, determining a second candidate beam of the UE based on the at least one of network related information or UE related information, among respective cooperative beam sets corresponding to the second candidate beam, determining a cooperative beam set corresponding to the UE based on the at least one of network related information or UE related information, wherein the cooperative beam set contains at least one cooperative beam corresponding to the second candidate beam, and among the second candidate beam and the determined cooperative beam set, determining the at least one first candidate beam corresponding to the UE.

According to an embodiment of the disclosure, for respective beams of the base station, determining cooperative beam sets of the beams corresponding to respective RSRP ranges based on RSRP information of beams reported by respective UEs within a pre-set time period respectively.

According to an embodiment of the disclosure, determining the cooperative beam sets of the beams corresponding to respective RSRP ranges comprises: determining a candidate cooperative beam set corresponding to respective RSRP values of the beam, grouping the RSRP values into different RSRP ranges, and constituting a cooperative beam set corresponding to the RSRP range with beams in candidate cooperative beam sets corresponding to respective RSRP values belonging to the same RSRP range.

According to an embodiment of the disclosure, determining the candidate cooperative beam set corresponding to respective RSRP values of the beam comprises: determining the UE with the largest RSRP value for the beam, and for each UE determined, based on the RSRP values of other beams fed back by the UE, selecting a first set number of third candidate beams from the other beams, and taking the beam and the selected first set number of third candidate beams as the candidate cooperative beam set corresponding to the largest RSRP value of the UE.

According to an embodiment of the disclosure, grouping the RSRP values into the different RSRP ranges comprises: a1) selecting a second set number of RSRP values from the RSRP values, b1) calculating a correlation coefficient between cooperative beam sets corresponding to the selected first RSRP value and the selected second RSRP value, and if the correlation coefficient is larger than a predefined threshold, dividing the two RSRP values into the same RSRP range, otherwise, dividing the two RSRP values into different RSRP ranges, c1) calculating correlation coefficients between cooperative beam sets of a next ungrouped RSRP value and RSRP values within an adjacent RSRP range, and if the minimum correlation coefficient is larger than the predefined threshold, grouping the ungrouped RSRP value into the adjacent RSRP range, otherwise forming another RSRP range, and d1) repeating step c1) until all selected RSRP values finish the operation of RSRP grouping.

According to an embodiment of the disclosure, grouping the RSRP values into the different RSRP ranges comprises: a2) selecting a third set number of RSRP values from the RSRP values, b2) in each iteration, based on the similarity between the cooperative beam set of the RSRP values and the cooperative beam set corresponding to the center of a group, joining the RSRP value to the group with the maximum similarity, c2) updating the center of each group as the mean vector of vectors corresponding to respective RSRP values in the group, and d2) based on the updated center of the group, repeating steps b2) and c2) until the grouping results of RSRP values are no longer changed.

According to an embodiment of the disclosure, determining the second candidate beam of the UE based on the at least one of network related information or UE related information among the respective beams of the base station comprises: based on the RSRP information of each beam reported by the UE, determining the beam corresponding to the largest RSRP value as the second candidate beam of the UE.

According to an embodiment of the disclosure, determining the cooperative beam set corresponding to the UE based on the at least one of network related information or UE related information among the respective cooperative beam sets corresponding to the second candidate beam comprises: among RSRP ranges respectively corresponding to respective cooperative beam sets of the second candidate beam, determining a RSRP range to which the RSRP value corresponding to the second candidate beam belongs, and based on the determined RSRP range, determining the cooperative beam set corresponding to the UE among the respective cooperative beam sets of the second candidate beam.

According to an embodiment of the disclosure, determining the at least one first candidate beam corresponding to the UE among the second candidate beam and the determined cooperative beam set comprises: instructing the UE to perform RSRP measurement on the second candidate beam and the beams in the determined cooperative beam set, and from the second candidate beam and the determined cooperative beam set, selecting a fourth set number of beams with the largest measured RSRP value as the first candidate beams corresponding to the UE.

According to an embodiment of the disclosure, determining the serving beam of the UE based on the determined first candidate beam comprises: acquiring an activation status of the determined first candidate beam, wherein the activation status comprises an active status and a non-active status, and determining the serving beam of the UE based on the first candidate beam in the active status.

According to an embodiment of the disclosure, the method further comprises: according to the NACK information fed back by the UE, updating the activation status of the first candidate beam.

According to an embodiment of the disclosure, updating the activation status of the first candidate beam comprises at least one of: if a number of continuous NACKs of the first candidate beam is not less than a first predefined value, updating the status of the first candidate beam to the non-active status, and if a number of the first candidate beams in the non-active status is not less than a second predefined value, updating the status of respective first candidate beams to the active status.

According to an embodiment of the disclosure, the method further comprises: when the number of the first candidate beams in the non-active status is not less than the second predefined value or a preset update time point is reached, instructing the UE to perform the RSRP measurement on respective first candidate beam, and updating the first candidate beam corresponding to the UE based on RSRP value measurement result.

According to an embodiment of the disclosure, determining the serving beam of the UE comprises: determining beam PF values of the respective first candidate beams, determining the serving beam of the UE according to the beam PF values of the respective first candidate beams.

According to an embodiment of the disclosure, determining the beam PF values of the respective first candidate beams comprises: a3) calculating a UE PF value of each UE under each corresponding first candidate beam, and b3) based on all UE PF values under each first candidate beam, determining the beam PF value respectively corresponding to each first candidate beam.

According to an embodiment of the disclosure, determining the serving beam of the UE according to the beam PF values of the respective first candidate beams comprises: c3) selecting the first candidate beam with the maximum beam PF value from the respective first candidate beams corresponding to respective UEs, d3) determining the selected first candidate beam as the serving beam of the corresponding UE, and e3) in the first candidate beams contained in antenna panels other than the antenna panel to which the selected first candidate beam belongs, performing steps c3) and d3) cyclically until each antenna panel contains the determined serving beam or there is no unscheduled UE.

According to an embodiment of the disclosure, determining the beam PF values of the respective first candidate beams comprises: calculating a total data rate and an average throughput of schedulable UEs for the first candidate beam, and calculating the beam PF value of the first candidate beam based on the total data rate, the average throughput, a weight of efficiency and a weight of fairness.

According to an embodiment of the disclosure, determining the serving beam of the UE comprises: determining UE PF value of the respective UEs under each corresponding first candidate beam, and determining the serving beams of the respective UEs according to the respective UE PF values and the usage of the antenna panels.

According to an embodiment of the disclosure, determining the serving beams of the respective UEs according to the respective UE PF values and the usage of the antenna panels comprises: a4) for the respective UEs, selecting the first candidate beam with the corresponding largest RSRP value from the first candidate beams of the UE, and b4) when the selected first candidate beam and its corresponding antenna panel are not used, selecting the first candidate beam as the serving beam of the UE, when the selected first candidate beam and its corresponding antenna panel have served other UE, selecting the first candidate beam as the serving beam of the UE, and when the antenna panel corresponding to the selected first candidate beam has served other UE, but the beam serving the other UE is not the selected first candidate beam, selecting the first candidate beam with the largest RSRP value from other first candidate beams, and performing step b4) until the serving beam of the UE is determined.

According to an embodiment of the disclosure, the method further comprises: based on the status information of respective frequency-domain or time-domain resources in the beam scheduling procedure, determining a frequency-domain or time-domain resource allocated to the UE according to beam interference detection.

According to an embodiment of the disclosure, determining the frequency-domain or time-domain resource allocated to the UE according to the beam interference detection comprises: determining interference beam information of respective resource blocks, based on the interference beam information of respective resource blocks, determining interference parameter information of the UE for respective resource blocks and signal quality information of interfered resource blocks, and based on the interference parameter information and the signal quality information, determining a start position and a number of resource blocks allocated to the UE.

According to an embodiment of the disclosure, determining the interference beam information of the respective resource blocks comprises: when the UE is served by a beam and occupies a resource block, confirming information of the beam as the interference beam information of the occupied resource block.

According to an embodiment of the disclosure, determining the interference parameter information of the UE for the respective resource blocks comprises: if at least one first candidate beam corresponding to the UE is contained in the interference beam information of the resource block, setting parameter value of the interference parameter information of the UE for the resource block as a parameter value indicating that the resource block is interfered, otherwise setting the parameter value of the interference parameter information of the UE for the resource block as a parameter value indicating that the resource block is not interfered, and determining the signal quality information of the interfered resource block comprising: setting the signal quality information of the interfered resource block as a ratio of the signal receiving power of the serving beam of the UE to the signal receiving power of all signals received by the UE.

According to an embodiment of the disclosure, determining the start position and the number of resource blocks allocated to the UE based on the interference parameter information and the signal quality information comprises: according to the interference parameter information, determining a resource block group consisting of continuous resource blocks without interference, when a number of resource blocks in the determined resource block group is larger than a number of resource blocks required by the UE to transmit data, selecting a resource block group with the smallest number of resource blocks that can meet the requirements of the UE, when the number of resource blocks in the determined resource block group is not larger than the number of resource blocks required for the UE to transmit data, selecting a resource block group with the largest number of resource blocks, and when there is no resource block group consisting of continuous resource blocks without interference, calculating a schedule benefit on a resource block group consisting of continuous resource blocks based on the signal quality information, and selecting the resource block group with the largest schedule benefit for the UE.

According to an embodiment of the disclosure, the method further comprises: when it is checked that a number of beam failures is larger than a set threshold, triggering the update of the cooperative beam set.

According to an embodiment of the disclosure, the relationship between the beam and the antenna panel indicates the correspondence between the antenna panel and the beam that it is able to transmit, and wherein the status information of respective frequency-domain or time-domain resources indicates whether the frequency-domain or time-domain resources are occupied or the UE occupying the frequency-domain or time-domain resources.

According to an aspect of the disclosure, there is provided a method for beam selection, comprising: determining beam PF values of respective beams of a base station, and determining a serving beam of a user equipment (UE) according to the beam PF values of the respective beams.

According to an embodiment of the disclosure, determining the serving beam of the UE comprises: determining UE PF value of respective UEs under each beam, determining the serving beams of the respective UEs according to the respective UE PF values and usage of an antenna panel.

According to an embodiment of the disclosure, determining the serving beams of the respective UEs according to the respective UE PF values and the usage of the antenna panel comprises: a4) for the respective UEs, selecting the beam with the corresponding largest RSRP value from respective beams, and b4) when the selected beam and its corresponding antenna panel are not used, selecting the beam as the serving beam of the UE, when the selected beam and its corresponding antenna panel have served other UE, selecting the beam as the serving beam of the UE, and when the antenna panel corresponding to the selected beam has served other UE, but the beam serving the other UE is not the selected beam, selecting the beam with the largest RSRP value from other beams, and performing step b4) until the serving beam of the UE is determined.

According to an aspect of the disclosure, there is provided an electronic device for beam selection, comprising: a module for acquiring network related information or user equipment (UE) related information for the beam selection, a module for determining at least one first candidate beam corresponding to the UE among beams of a base station based on the at least one of network related information or UE related information, and a module for determining a serving beam of the UE based on the determined at least one first candidate beam.

According to an aspect of the disclosure, there is provided an electronic device for beam selection, comprising: a processor, and a memory for storing computer program instructions, wherein when the computer program instructions are loaded and executed by the processor, the processor performs the method according to the embodiment of the disclosure.

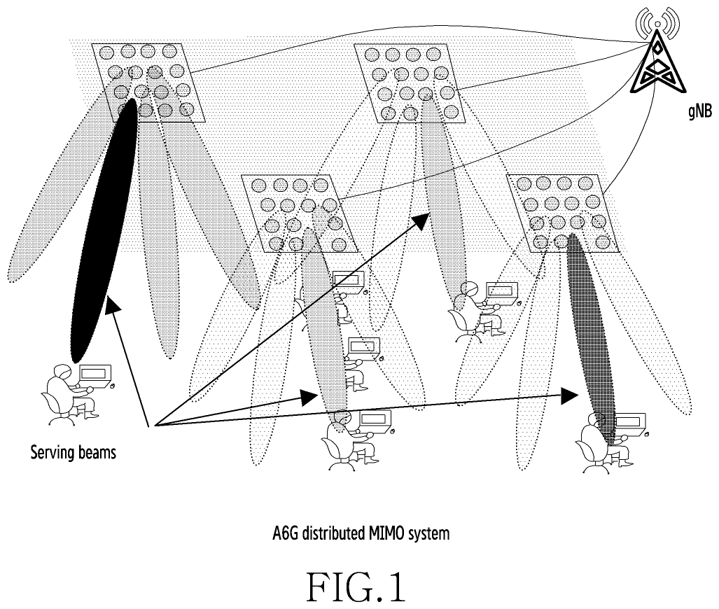

FIG. 1 shows a schematic diagram of an A6G distributed MIMO system according to an embodiment of the disclosure.

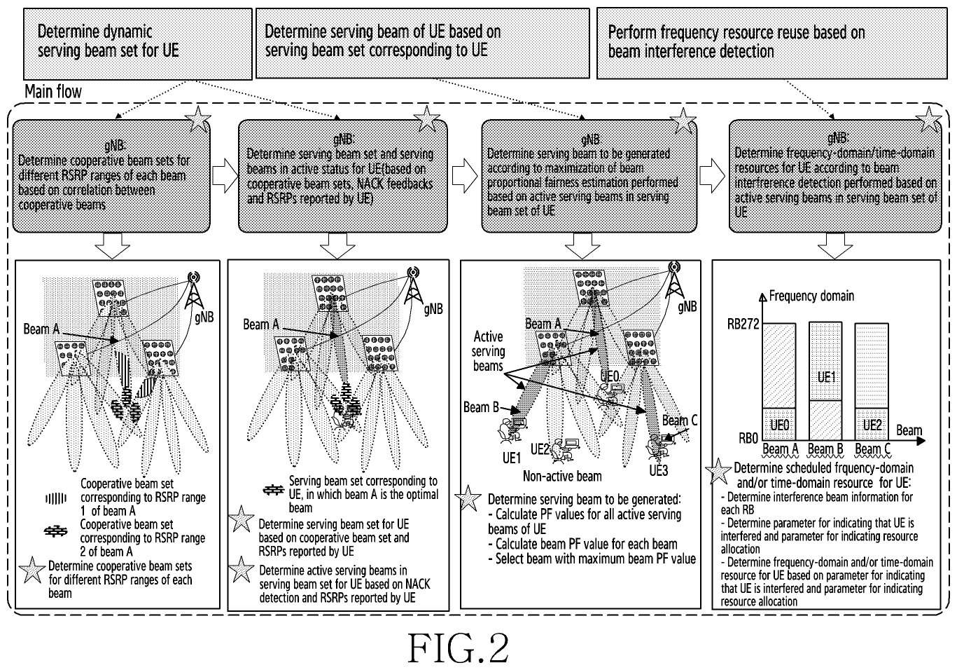

FIG. 2 is a schematic diagram of an inventive concept according to an embodiment of the disclosure.

Referring to FIG. 2, the gNB side may include four steps as follows.

Step 1: Collect information.

The gNB periodically or aperiodically collects relevant information for beam selection reported by the UE or obtained from other entities.

Step 2: Determine a serving beam set corresponding to the UE, for example, determine a dynamic serving beam set for the UE.

Step 2-0: Determine cooperative beam sets corresponding to different RSRP (Reference Signal Receiving Power) ranges of respective beams in the cell served by the gNB. At the gNB, the cooperative beam sets are determined for different RSRP ranges of each beam based on the correlation between cooperative beams. A RSRP range can also be called a RSRP interval.

A cooperative beam set can also be called a cooperative beam collection, and includes at least one cooperative beam which can be regarded as a candidate serving beam.

As shown in FIG. 2, the beam A corresponds to different cooperative beam sets in different RSRP ranges.

Step 2-1: Determine the serving beam set of the UE and serving beams in the active status in the serving beam set.

The serving beam set includes at least one first candidate beam, and then the serving beam of the UE can be selected from the serving beam set (that is, from the at least one first candidate beam).

Furthermore, respective first candidate beams in the serving beam set contains beams in the active status and beams in the non-active status, and beams in the active status (which can also be called serving beams in the active status or active serving beams) in the serving beam set can be further determined.

The serving beam of the UE refers to the beam through which the UE performs data transmission.

At the gNB, based on the cooperative beam set, NACK feedback and the RSRP reported by the UE, the serving beam set and serving beams in the active status are determined for the UE. For example, the serving beam set is determined for the UE based on the cooperative beam set and the RSRP reported by the UE. And, based on NACK detection and the RSRP reported by the UE, an active serving beam in the serving beam set is determined for the UE.

In FIG. 2, multiple beams containing a beam A constitute the serving beam set of the UE, in which the beam A is the optimal serving beam (optimal beam) of the UE, that is, the beam with the largest RSRP.

Step 3: Determine the serving beam of the UE (that is, the serving beam to be generated by the gNB) based on the serving beam set corresponding to the UE. For example, the serving beam to be generated is selected for the gNB based on maximization of beam proportional fairness (PF) estimation (e.g., PF value). The beam PF value can reflect the data transmission capability of the beam in consideration of fairness. The beam PF value can be decided by PF values corresponding to all UEs on the beam.

In the gNB, the serving beam to be generated is determined according to the maximization of beam proportion fair estimation which can be performed based on the active serving beams in the serving beam set of the UE.

For example, determining the serving beam to be generated may include:

calculating PF values for all active serving beams of the UE;

calculating a beam PF value for each beam;

selecting the beam with the maximum beam PF value.

Step 4: Determine a frequency-domain and/or time-domain resource allocated to the UE according to beam interference detection. Specifically, frequency resource reuse is performed based on the beam interference detection.

The gNB generates the serving beam to be generated as above and transmits the corresponding UE data on the corresponding frequency-domain and/or time-domain resources. For example, at the gNB, the frequency resource is determined for the UE according to the beam interference detection performed based on the active serving beams in the serving beam set of the UE.

For example, determining the scheduled frequency resource for the UE may include:

determining interference beam information, such as an interference beam list, for each resource block (RB);

determining parameters for indicating that the UE is interfered (which can be called interference parameter information, for example, a UE interfered flag interfered_flag can be set) and parameters for indicating resource allocation (which can be called signal quality information of interfered resource block, for example, a resource allocation factor res.allocation factor can be set);

determining frequency-domain and/or time-domain resources for the UE based on parameters for indicating that the UE is interfered and parameters for indicating resource allocation.

According to the embodiment of the application, firstly, the gNB collects data reported by the UE or obtained from other entities (periodically or aperiodically), and determines the serving beam sets and active serving beams corresponding to respective UEs, so as to be able to meet the requirements of performing fast and dynamic UE serving beam selection in an A6G distributed mMIMO system.

The collected data can be used to determine the cooperative beam sets corresponding to different Reference Signal Receiving Power (RSRP) ranges of respective beams in the cell served by the gNB, the serving beam set of the UE, active serving beams, the serving beam to be generated by the gNB and the frequency resources corresponding to the UE.

In the procedure, an Artificial Intelligence (AI) method can be employed to divide different RSRP ranges under respective beams.

Then, according to the serving beam set and the active serving beams determined for the UE, a serving beam to be generated of the cell served by the gNB, that is, the serving beam of the UE, is determined. When the serving beam to be generated is determined, the antenna panel corresponding to the serving beam to be generated, that is, the antenna panel transmitting the beam, can also be determined.

Finally, the frequency-domain and/or time domain resource corresponding to the UE are determined according to the serving beam set and the active serving beams determined for the UE. The UE is the UE served by the serving beam to be generated of the cell served by the gNB.

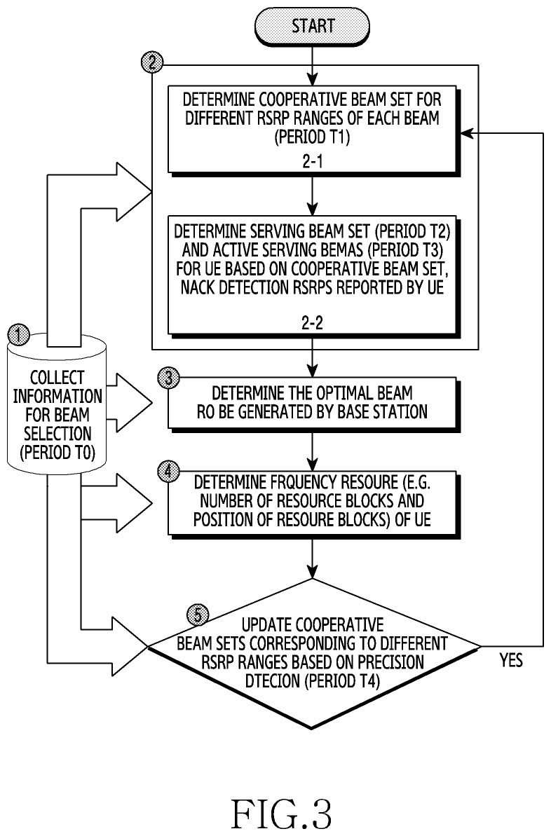

FIG. 3 is a flowchart of a beam selection method according to an embodiment of the disclosure.

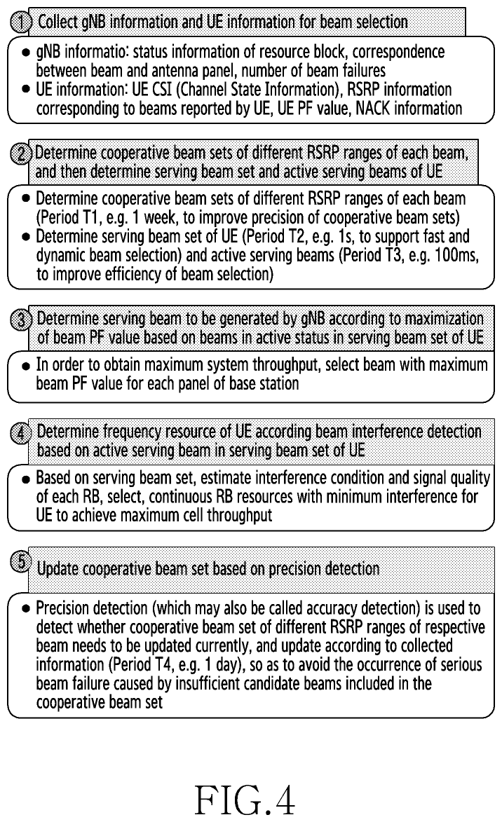

FIG. 4 is a diagram of a beam selection method according to an embodiment of the disclosure. Embodiments of the disclosure will be described below with reference to FIGS. 3 and 4.

Step 1: Information for beam selection, including network related information and UE related information, is collected.

The UE can generate a large amount of measurement report information and statistical information. The UE may not actively upload all the information to the network side, unless the network side equipment has clear requirements, then the network side equipment (such as the gNB) may send the signaling corresponding to collection of required information to the UE to make the UE report relevant information. Of course, some entities on the network side themselves may also save UE related information, so the UE related information can also be collected from corresponding entities on the network side. In the application, the gNB needs to determine the serving beams to be generated for different antenna panels corresponding to the distributed mMIMO of the cell, and the gNB needs to collect, from the UE and entities on the network side, relevant information including:

Network related information (which can also be called base station information or gNB information), including at least one of the numbers of beam failures in respective beams, the relationship between the beam and the antenna panel, the status information of respective frequency-domain and/or time-domain resources (for example, resource blocks) in the beam scheduling procedure (including whether it is occupied, and/or by which UE or UEs it is occupied, etc.), etc. Here, the beam failure means that the channel quality of the beam detected by the UE is continuously lower a certain threshold for a period of time, or transmission of the UE signal fails on the beam; and the relationship between the beam and the antenna panel indicates the correspondence between the antenna panel and the beam that it can transmit. In addition, in the procedure of beam selection, a beam can have multiple candidate antenna panels, but after the beam is selected to be transmitted by a certain antenna panel, other antenna panels can no longer transmit the beam.

UE related information (which may also be called UE information), including at least one of RSRP information corresponding to beams reported by the UE, Negative-Acknowledgement (NACK) information identifying that the corresponding data block (or transmission block) was not successfully transmitted, RSRP information corresponding to respective beams in the serving beam set, and PF (proportional fairness) values of the UE on different serving beams. Here, the RSRP information corresponding to the beam can be received by receiving channel state information (CSI) corresponding to the UE.

The collection of the UE and base station/network related information can be periodic (e.g., the period is T0=15 minutes) or aperiodic (e.g., it is collected once as required or only when the set data deviation is larger than the set threshold).

Step 2: The cooperative beam sets of different RSRP ranges of each beam is determined, and the serving beam set and active serving beams of the UE are determined based on the cooperative beam sets.

In an A6G D-mMIMO (Distributed Massive MIMO) system, an area can be covered by multiple beams with good signal quality. These beams can provide good data transmission for the UE.

In order to support fast and dynamic UE serving beam decision and avoid interruption of data transmission due to a posture change of the UE, a serving beam set is created for each UE. A serving beam set is a kind of beam set in which the beams are candidate serving beams corresponding to the UE, and the serving beam of the UE, that is, the beam that ultimately provides data transmission for the UE, can be selected from these candidate serving beams. Beams in the serving beam set have good signal quality. When the UE measures that the signal quality of the beam get worse (e.g., due to a posture change), another beam can be directly selected from the serving beam set to provide data transmission for the UE, which can greatly reduce the time of selecting beams for the UE, reduce or decrease the problem of data transmission interruption due to the transmission signal being blocked and the posture change of the UE, and also improve the throughput of the system.

In order to reduce the time of determining the serving beam set of the UE, a cooperative beam set can be created firstly according to the collected historical RSRP information for different RSRP ranges of each beam. A cooperative beam set is a kind of beam set in which the beams are candidate serving beams of the RSRP range corresponding to the UE. The cooperative beam sets correspond to different spatial positions. The cooperative beam set is determined according to the RSRP of the optimal beam reported by the UE. When determining the serving beam set of each UE, only the beams in the cooperative beam set need to be measured. At last, a beam with a good measurement value (such as RSRP) for UE in the cooperative beam set will be selected as a beam in the serving beam set of the UE.

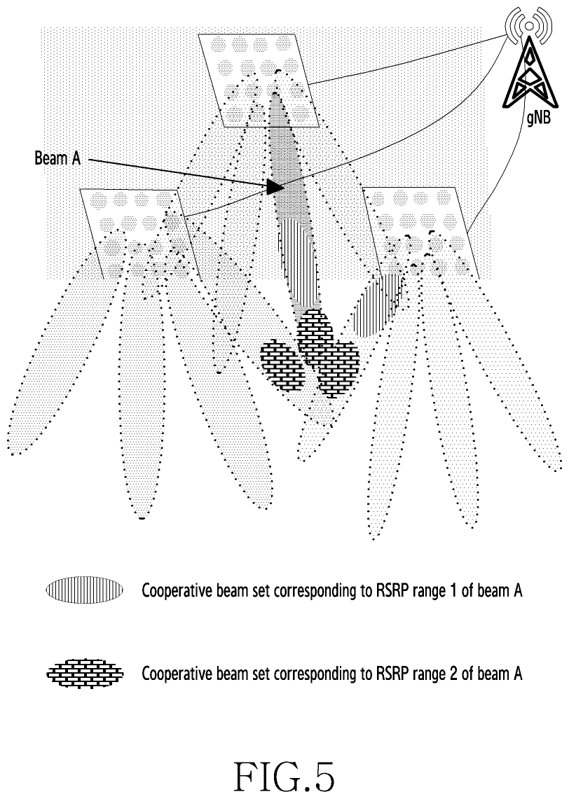

FIG. 5 is a schematic diagram of a cooperative beam according to an embodiment of the disclosure.

Next, step 2 will be described in detail by way of example.

Step 2-1: Cooperative beam sets corresponding to different RSRP ranges of each beam are determined.

Different RSRP values of the beam correspond to different spatial positions, so different RSRP values of the beam may correspond to different cooperative beam sets. In order to reduce the complexity of cooperative beam set maintenance, firstly, RSRP values with similar cooperative beam sets are grouped into one RSRP range, and then, one cooperative beam set is maintained for one RSRP range.

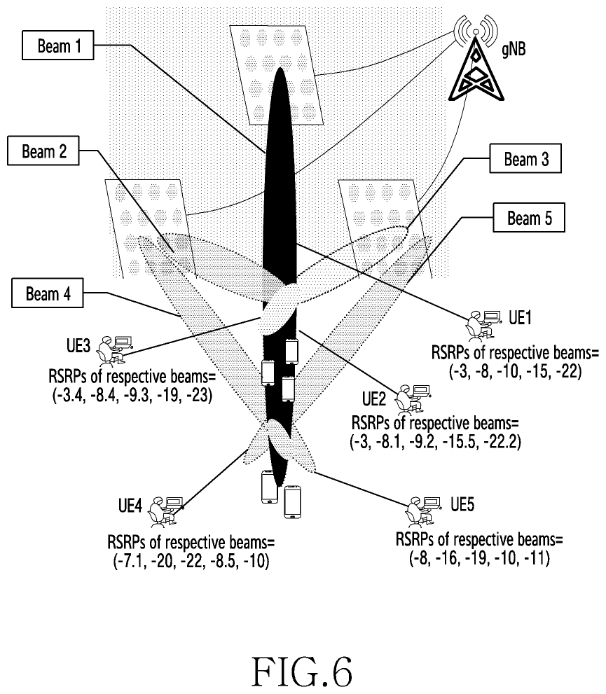

FIG. 6 is a schematic diagram of RSRP values corresponding to respective beams according to an embodiment of the disclosure.

Step 2-1 may be performed periodically, for example, the period may be T1, such as 1 week, to improve the precision of the cooperative beam set.

Step 2-1 may include the following steps:

Step 2-1-1: The gNB collects RSRP values corresponding to respective beams reported by all UEs within a period of time (for example, periodic collection may be performed according to the period T1).

Step 2-1-2: The gNB determines candidate cooperative beam sets of respective RSRP values of respective beams.

At first, UEs with the largest RSRP value of respective beams are determined, and for each determined UE, based on the RSRP values of other beams fed back by the UE, a first set number (e.g., 2) of third candidate beams are selected from the other beams, and the beam and the selected third candidate beams are taken as a candidate cooperative beam set corresponding to the largest RSRP value of the UE.

<Beam 1, Antenna panel 1> is taken as an example:

(a) The UE whose optimal beam (the beam with the largest RSRP value) is <Beam 1, Antenna panel 1> is selected. A table for recording history beam RSRP values reported by the UE is created, as shown in Table 1. For each UE, the beam with the largest RSRP value is the optimal beam of the UE. Here, the beam with the largest RSRP value is a kind of candidate beam, which can be called a second candidate beam, for example.

(b) For each UE in Table 1, several other beams, for example, two beams, are selected in the descending order of RSRP, as shown in Table 2. The selected beam can be called a third candidate beam.

(c) If the optimal beams of UEs in Table 2 have the same RSRP value, the above selected other beams of these UEs are merged into the same candidate cooperative beam set corresponding to the RSRP, as shown in Table 3.

TABLE 1

| | RSRP value of | RSRP value of | RSRP value of | RSRP value of | RSRP value of |
|---|---|---|---|---|---|
| | <Beam 1, | <Beam 2, | <Beam 3, | <Beam 4, | <Beam 5, |
| UE | Antenna panel 1> | Antenna panel 2> | Antenna panel 3> | Antenna panel 2> | Antenna panel 3> |
| 1 | −3 | −8 | −10 | −15 | −22 |
| 2 | −3 | −17 | −8.1 | −9.2 | −22.2 |
| 3 | −4 | −8.4 | −9.3 | −19 | −23 |
| 4 | −7 | −20 | −22 | −8.5 | −10 |
| 5 | −8 | −16 | −19 | −10 | −11 |

TABLE 2

| | RSRP value of | RSRP value of | RSRP value of | RSRP value of | RSRP value of |
|---|---|---|---|---|---|
| | <Beam 1, | <Beam 2, | <Beam 3, | <Beam 4, | <Beam 5, |
| UE | Antenna panel 1> | Antenna panel 2> | Antenna panel 3> | Antenna panel 2> | Antenna panel 3> |
| 1 | −3 | −8 | −10 | −15 | −22 |
| 2 | −3 | −17 | −8.1 | −9.2 | −22.2 |
| 3 | −4 | −8.4 | −9.3 | −19 | −23 |
| 4 | −7 | −20 | −22 | −8.5 | −10 |
| 5 | −8 | −16 | −19 | −10 | −11 |

TABLE 3

| RSRP value of | Candidate |
|---|---|
| <Beam 1, | cooperative |
| Antenna panel 1> | beam set |
| −3 | (<Beam 2, Antenna panel 2>, |
| | <Beam 3, Antenna panel 3>, |
| | <Beam 4, Antenna panel 2>) |
| −4 | (<Beam 2, Antenna panel 2>, |
| | <Beam 3, Antenna panel 3>) |
| −7 | (<Beam 4, Antenna panel 2>, |
| | Beam 5, Antenna panel 3>) |
| −8 | (<Beam 4, Antenna panel 2>, |
| | <Beam 5, Antenna panel 3>) |

Step 2-1-3: RSRP values are grouped into different RSRP ranges, and each RSRP range and its corresponding cooperative beam set may be determined based on a non-AI method or an AI method. Table 4 shows the cooperative beam set of each RSRP range determined according to Table 3. Compared with a non-AI method, an AI-based algorithm can achieve better grouping performance. However, the AI method usually needs several rounds of iterations to finally converge. Compared with the AI-based algorithm, the non-AI-based algorithm does not need to be subject to multiple iterations, and have lower requirements on the computing capability of base stations.

TABLE 4

| | RSRP range of | |
|---|---|---|
| RSRP | <Beam 1, | Cooperative |
| range index | Antenna panel 1> | beam set |
| 1 | [−3, −4] | (<Beam 2, Antenna panel 2>, |
| | | <Beam 3, Antenna panel 3>, |
| | | <Beam 4, Antenna panel 2>) |
| 2 | [−7, −8] | (<Beam 4, Antenna panel 2>, |
| | | <Beam 5, Antenna panel 3>) |

For the i-th RSRP index of a beam, it is defined that Aᵢ=[aᵢ₁ aᵢ₂, . . . , a_{iM}], where M is the total number of beams. If beam m is in the candidate cooperative beam set of RSRP i, then aᵢₘ=1; otherwise, aᵢₘ=0. Aᵢ can characterize which cooperative beams the i-th RSRP index corresponds to. If aᵢₘ=1, it means that beam m is the cooperative beam of the i-th RSRP index; if aᵢₘ=0, it means that beam m is not the cooperative beam of the i-th RSRP index.

A non-AI method for determining the RSRP range and its corresponding cooperative beam set is as follows.

For each beam, RSRP values are grouped based on the correlation of cooperative beam sets corresponding to different RSRP values.

a1) A second set number (X, such as 30) of RSRPs are uniformly selected from the ordered RSRP values.

b1) The correlation coefficient ρ_{1,2} between cooperative beam sets corresponding to the first and second selected RSRP values is calculated according to Equation 1:

$${ρ}_{1 , 2} = \frac{\vert {A}_{1} {A}_{2}^{H} \vert}{‖ {A}_{1} ‖ ‖ {A}_{2} ‖} \qquad Equation 1$$

If the correlation coefficient ρ_{1,2}>the preset threshold Cor_Th, the two RSRPs will belong to the same RSRP range; otherwise, they are divided into different ranges.

c1) Correlation coefficients between cooperative beam sets of a next ungrouped RSRP and all RSRPs within an existing adjacent RSRP range are calculated. If the minimum correlation coefficient is larger than Cor_Th, the ungrouped RSRP is grouped into the adjacent RSRP range; otherwise, another RSRP range is formed. Step c1) is repeated until all RSRPs finish the operation of RSRP grouping.

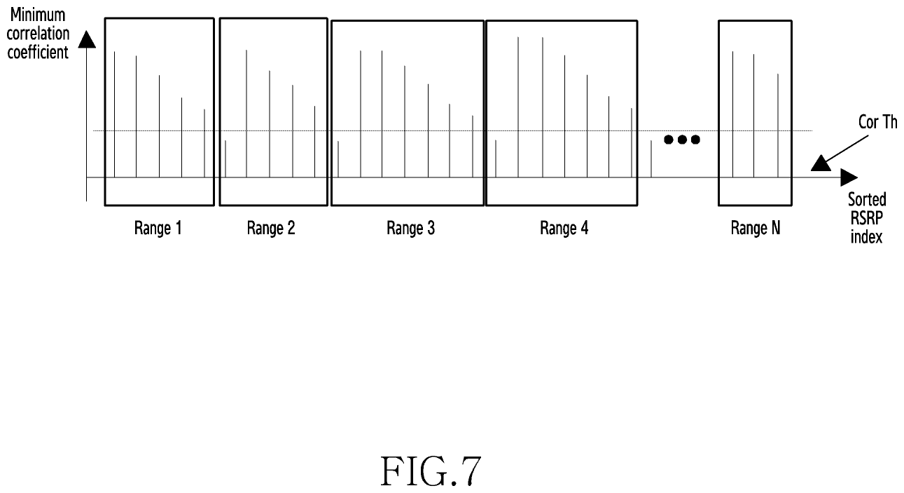

FIG. 7 is a schematic diagram showing the determination of a RSRP range and its corresponding cooperative beam set based on a non-AI method according to an embodiment of the disclosure.

An AI method for determining cooperative beam set of each RSRP range is as follows.

RSRPs can be grouped based on K-means clustering method.

a2) A third set number (Y, e.g. 4) of RSRPs are uniformly selected from the ordered RSRPs as the initial center of each RSRP group m. For example, there are 24 RSRPs, and RSRP indexes 3, 9, 15 and 21 are selected as the center of the group, then π₀=A₃, π₁=A₉, π₂=A₁₅, π₃=A₂₁.

b2) In each iteration, based on the similarity between the cooperative beam set of the RSRP and the cooperative beam set corresponding to the center of the group, the RSRP joins the group with the maximum similarity. The similarity can be determined according to Euclidean distance. For example, the similarity is calculated according to the following Equation 2:

dist(πⱼ,Aᵢ)=∥πⱼ−Aᵢ∥₂ Equation 2

c2) The center of each group is updated as the mean vector of the vectors A corresponding to respective RSRPs in the group.

d2) Based on the updated center of the group, steps b2) and c2) are repeated until the grouping result of RSRPs is no longer changed.

After grouping based on the above steps, each RSRP group corresponds to one RSRP range.

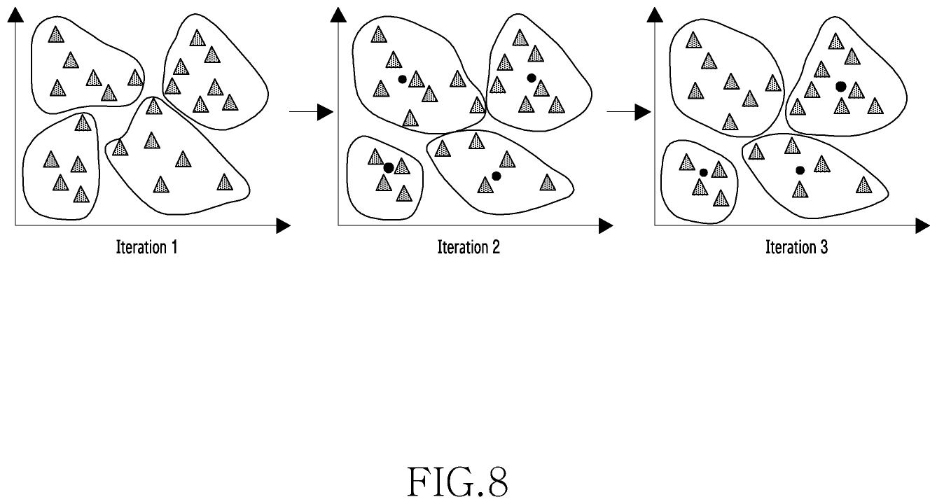

FIG. 8 is a schematic diagram showing the determination of a RSRP range and its corresponding cooperative beam set based on an AI method according to an embodiment of the disclosure.

2-1-4: Beams in the candidate cooperative beam set corresponding to respective RSRPs belonging to the same RSRP range constitute the cooperative beam set corresponding to the RSRP range.

By means of the above step 2-1, the time for determining the serving beam set of the UE can be shortened.

Step 2-2: The serving beam set and active serving beams of the UE are determined.

The serving beam set and active serving beams of the UE can be determined based on the RSRPs reported by the UE, the cooperative beam sets maintained by the base station side and the detected NACKs.

The serving beam set can be determined periodically, and the period can be T2, such as 1 s, to support rapid and dynamic beam selection. The active serving beam can be determined periodically, and the period can be T3, such as 100 ms, to improve the efficiency of beam selection.

Here, the serving beam of the UE can represent the beams where the UE performs data transmission, and the serving beam set is a set of candidate beams that the UE can use for signal transmission, so the beams in the serving beam set should have good signal quality. By establishing the serving beam set, the UE can quickly select the optimal beam from the serving beam set of the UE to serve, thus reducing the complexity of beam selection and the time for finding the optimal beam for the UE.

The serving beam set of the UE is determined based on the RSRP measurement results of the beams in the cooperative beam set. At first, the beam with the largest RSRP is taken as the optimal serving beam (which can also be called the optimal beam) of the UE. Then, the cooperative beam set of the RSRP range corresponding to the optimal beam is taken as the original beam set. Further RSRP measurements are made on the optimal beam and the beams in the original beam set, and several beams of the strongest RSRPs are taken as the serving beam set of the UE. The step ensures that all beams in the serving beam set of the UE have good signal quality.

However, due to the different posture change of users, the signals of the beams in the serving beam set may be temporarily blocked. In order to avoid the interruption of data transmission caused by signal being temporarily blocked and ensure the quality of UE's service, the statuses (the active status or the non-active status) of respective beams in the serving beam set can be decided by periodic updating and event triggering based on NACK detection. By selecting a beam from the beams in the active status, it is ensured that the UE selects the serving beam from the beams with real-time high signal quality (i.e., the beams in the active status) at any time, thus guaranteeing the performance of the UE. In the embodiment of the application, the beam in the active status can be used as a kind of candidate beam.

Step 2-2-1: The optimal beam of the UE is determined among respective beams of the base station.

Based on the RSRP of each beam reported by the UE, the beam with the largest RSRP is determined as the second candidate beam of the UE, which can also be called the optimal beam (e.g., periodic determination can be made according to the period T2).

Step 2-2-2: The serving beam set of the UE is determined.

In the embodiment of the application, the cooperative beam set corresponding to the UE can be determined among respective cooperative beam sets corresponding to the optimal beam of the UE, and then at least one first candidate beam corresponding to the UE is determined as the serving beam set of the UE among the optimal beam and the determined cooperative beam set.

Specifically:

1) Among the RSRP ranges corresponding respectively to respective cooperative beam sets of the optimal beam, according to the RSRP of the optimal beam, the corresponding RSRP range, that is, the RSRP range to which the RSRP value of the optimal beam belongs, is determined.

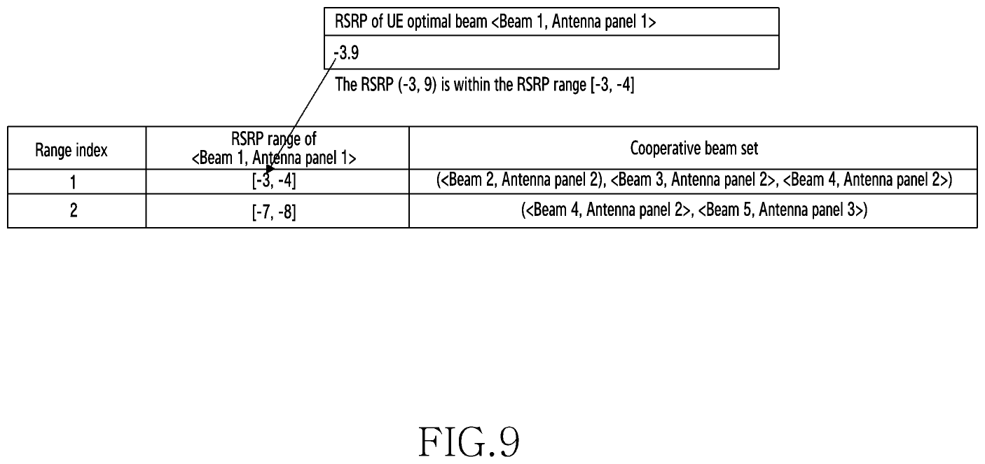

FIG. 9 shows a schematic diagram of determining the RSRP range corresponding to the UE according to the RSRP of an optimal beam according to an embodiment of the disclosure.

2) Based on the determined RSRP range, the cooperative beam set corresponding to the UE is determined among respective cooperative beam sets of the optimal beam.

Specifically, among respective cooperative beam sets of the optimal beam, the cooperative beam set corresponding to the determined RSRP range is taken as the cooperative beam set of the UE. The cooperative beam set as determined above can also be called the original serving beam set.

3) Reference signals are configured for the above optimal beam and the beams in the original serving beam set to perform further RSRP measurements. When the UE initially measures the RSRP, it will report the RSRP of all perceived beams (that is, the RSRP reported when the cooperative beam set is initially determined). Therefore, after the original serving beam set and the optimal beam are selected, the measurement signal can be reconfigured to perform RSRP measurements on only these beams, thus reducing the measurement range and improving the efficiency. Moreover, because the channel is time-varying, re-measurement can reflect the channel state more accurately. Furthermore, these reconfigured reference signals can also be used when updating the activation status of the beam later.

4) A fourth set number (Z, such as 2) of beams with the strongest RSRPs (containing beams in the original serving beam set and the optimal beam) are selected as beams in the serving beam set of the UE, that is, the first candidate beams. Referring to Table 5 below, it is shown that beam 1 of antenna panel 1 and beam 2 of antenna panel 2 are selected as beams in the serving beam set.

TABLE 5

| <Beam 1, | <Beam 2, | <Beam 3, | <Beam 4, |
|---|---|---|---|
| Antenna | Antenna | Antenna | Antenna |
| panel 1> | panel 2> | panel 2> | panel 2> |
| −3.9 | −6.2 | −7 | −10 |

Step 2-2-3: The activation statuses of respective beams are updated in the serving beam set.

Although the serving beam set is composed of several beams with the strongest RSRPs among the original serving beam set and the optimal beam, the serving beam of the UE may be temporarily blocked due to different posture change of the UE, and the signal quality may vary. In order to characterize the relatively real-time serving beam quality of the UE, the activation status of the beam is divided into two different statuses: active and non-active. Non-active can also be called deactivated. Beams with poor signal quality at will be set to the non-active status, and only the beams in the active status can be used for data transmission, that is to say, the serving beams for user data transmission are selected from the beams in the active status in the serving beam set of the UE.

Two mechanisms can be used to update the activation status of beams: event-triggered update and periodical update.

Event-triggered update (that is, the update is performed according to NACK information fed back by the UE, that is, the update is performed when continuous NACKs are detected) includes:

1) when NACKs for the current serving beam of the UE are continuously received, the signal quality of the current serving beam of the UE may deteriorate rapidly due to blocking the beam caused by the posture change of the UE and other reasons, and it is no longer suitable for data transmission, so it is necessary to update the status of the beam in the serving beam set to the non-active status;

2) when most or a predefined number of beams in the serving beam set are deactivated, all beams in the serving beam set can be set to the active status, and RSRPs can be re-measured to update the serving beam set of the UE.

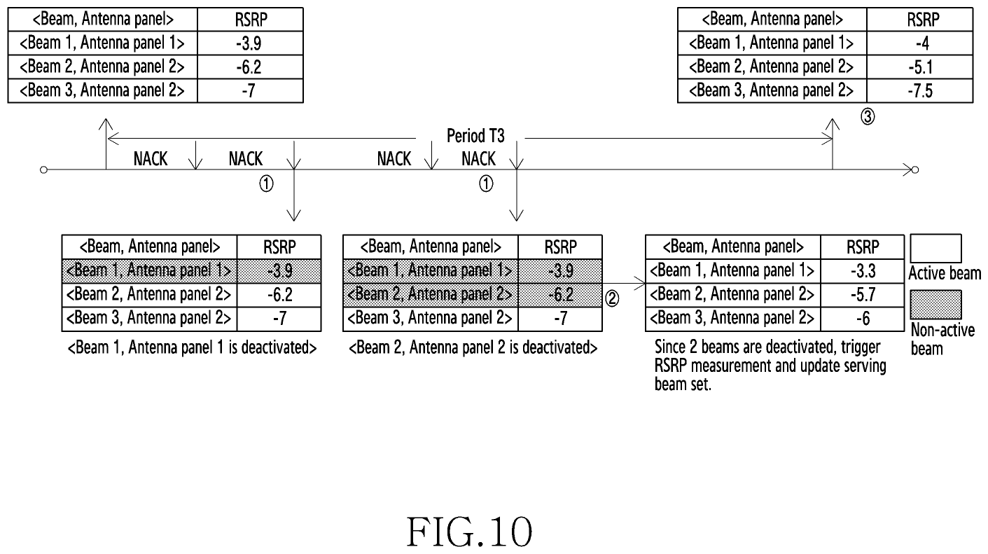

FIG. 10 is a schematic diagram of beam status update according to an embodiment of the disclosure. The beam status update according to an embodiment of the application will be described below with reference to FIG. 10.

1. If continuous NACKs (for example, K times or more) occur on a certain beam in the serving beam set of the UE, and the number of NACKs is not less than a first predefined value, the beam is deactivated, that is, the status of the beam is updated to the non-active. See \textcircled{1} in FIG. 10.

2. If the number of beams in the non-active status is not less than a second predefined value, for example, (P-1) beams in the serving beam set are all deactivated, the statuses of respective beams in the serving beam set are updated to the active status. P represents the number of beams of the serving beam set of the UE, but P is not limited thereto and can be any other suitable number. See \textcircled{2} in FIG. 10.

In addition, it is also possible to update the serving beam set of the UE, that is, the first candidate set corresponding to the UE. Specifically, when the number of beams in the non-active status in the serving beam set is not less than the second predefined value (Mode 1) and/or a preset update time point is reached (Mode 2), the UE is instructed to perform RSRP measurement on respective beams in the serving beam set, and the serving beam set corresponding to the UE is updated based on the measurement results of RSRP values.

Mode 1: If the number of beams in the non-active status is not less than the second predefined value, for example, (P-1) beams in the serving beam set are all deactivated, RSRP re-measurement is triggered for all beams in the serving beam set of the UE, and the serving beam set of the UE can be updated according to the measurement results, that is, the first candidate beam corresponding to the UE is updated.

Mode 2: Periodical Update: After a certain time (i.e., set period T3) elapses, the signal strength of the beams in the serving beam set of the UE may also vary, and the order or statuses of respective beams need to be adjusted. By periodically updating, it is possible to re-determine whether respective beams in the serving beam set are suitable for transmitting data. The RSRPs of all beams in the serving beam set of the UE are periodically measured, and the activation statuses of respective beams in the serving beam set are updated based on the latest RSRP measurement result. See \textcircled{3} in FIG. 10.

If the optimal beam of the UE changes or the range corresponding to the RSRP of the optimal beam changes after the base station receives the new RSRP measurement result, then the cooperative beam set and the serving beam set can be updated. In order to avoid frequent update of the serving beam set caused by excessively frequent measurement and reporting of RSRPs, a prohibition timer can be set. If the timer does not expire, the cooperative beam set and the serving beam set will not be updated even if there is a new RSRP measurement result.

With the above steps, the serving beam set corresponding to the UE and the activation statuses of respective beams in the serving beam set are updated, so that a better serving beam can be selected to ensure the performance of the UE.

Step 3: The serving beam to be generated by the gNB is determined according to maximization of the beam PF value based on beams in the active status in the serving beam set of the UE.

Maximizing system capacity is an important goal of a wireless communication system algorithm design. However, in actual systems, in order to ensure that UEs with different signal qualities can all obtain relatively fair service quality, the principle of proportional fairness is introduced, and the scheduling order of users is decided by considering throughput and scheduling fairness comprehensively. Scheduling PF value is a measurement yardstick of getting higher throughput in consideration of fairness.

The beam PF value can be the sum of PF values of all users under the beam. According to the principle of proportional fairness, the higher the PF value of a beam is, the larger the throughput that the beam can obtain is. Considering fairness, the throughput of the system can be maximized by selecting the beam with the maximum beam PF value to perform a schedule for each antenna panel of the base station.

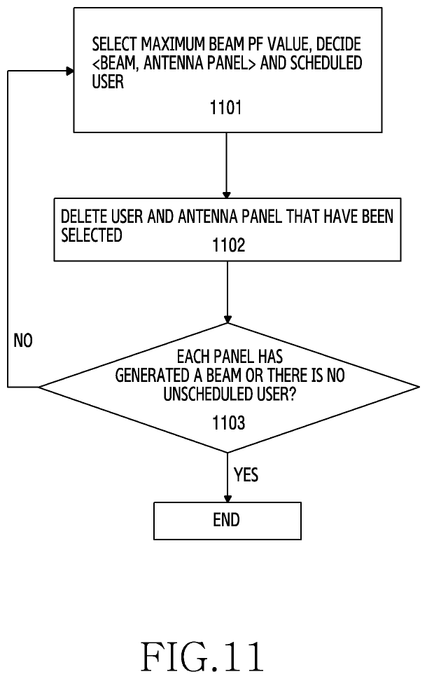

FIG. 11 is a flowchart of deciding a serving beam to be generated by the gNB according to an embodiment of the disclosure. The specific flow of step 3 is shown in FIG. 11.

Referring to FIG. 11, at operation 1101, the maximum beam PF value is selected, and <beam, antenna panel> and a scheduled user are decided. At operation 1102, the selected user and antenna panel are deleted. At operation 1103, it is judged whether each antenna panel has generated a beam or there is no unscheduled user. If so, the procedure ends. If not, return to operation 1101.

Step 3 is described in detail below.

Step 3-1: The PF value of each UE under each beam in the active status in the serving beam set (i.e., UE PF value) is calculated.

The beam in the active status is selected from the serving beam set of the UE, which has been decided by step 2.

The PF value of the user under each beam in the active status is decided by the following Equation 3:

$$PF of user under a beam = \frac{Signal to Noise Ratio of beam}{Average throughput of user under the beam} \qquad Equation 3$$

Step 3-2: The beam with the maximum beam PF value is selected as the serving beam to be generated by the corresponding antenna panel. Deciding the serving beam to be generated by the antenna panel is as follows:

Beam PF values of all selectable beams (beams in the active status in the serving beam set) are calculated according to the following Equation 4.

Σᵢ₌₁^{users under the beam} Beam PF value=PF value of user I under the beam Equation 4

Among all selectable beams, the beam with the maximum beam PF value is selected as the serving beam to be generated by the corresponding antenna panel.

Deciding scheduled user is as follows: if the active serving beam of the user is the same as the selected serving beam to be generated, the user will be scheduled, and be deleted from the candidate user queue. The scheduling order of users under the same serving beam to be generated is decided by the descending order of PF values of users under the beam.

TABLE 6

| User PF | Antenna panel 1 | | Antenna panel 2 | | Antenna panel 3 | |
|---|---|---|---|---|---|---|
| value | Beam 1 | Beam 2 | Beam 3 | Beam 4 | Beam 5 | Beam 6 |
| User 1 | | 77 | 50 | | 55 | |
| User 2 | 60 | | | 90 | | |
| User 3 | | | | | | 103 |
| User 4 | | 63 | | | | |
| User 5 | 44 | | | | | 62 |
| Beam PF | 104 | 140 | 50 | 90 | 55 | 165 |

The above table 6 shows the PF values and beam PF values of respective users under respective beams.

TABLE 7

| User PF | Antenna panel 1 | | Antenna panel 2 | | Antenna panel 3 | |
|---|---|---|---|---|---|---|
| value | Beam 1 | Beam 2 | Beam 3 | Bearn 4 | Beam 5 | Beam 6 |
| User 1 | | 77 | 50 | | 55 | |
| User 2 | 60 | | | 90 | | |
| User 3 | | | | | | 103 |
| User 4 | | 63 | | | | |
| User 5 | 44 | | | | | 62 |
| Beam PF | 104 | 140 | 50 | 90 | 55 | 165 |

As shown in Table 7 above, the beam PF value of <Beam 6, Antenna panel 3> is the maximum, and User 3 in the beam has the maximum user PF value, so User 3 will be the first to be served by Antenna panel 3 with Beam 6. User 5 will be the second to be served by Antenna panel 3 with Beam 6. Once the user is scheduled, the row where the user is located is deleted.

Step 3-3: An antenna panel that has generated beams is deleted, a beam that have been generated by other antenna panel is deleted, and the operations of the first two steps are looped until each antenna panel has generated beams or there is no unscheduled user.

TABLE 8

| UE PF | Antenna panel 1 | | Antenna panel 2 | | Antenna panel 3 | |
|---|---|---|---|---|---|---|
| value | Beam 1 | Beam 2 | Beam 3 | Beam 1 | Beam 2 | Beam 3 |
| UE1 | | 77 | 50 | | 55 | |
| UE2 | 60 | | | 90 | | |
| UE3 | | | | | | 103 |
| UE4 | | 63 | | | | |
| UE5 | 44 | | | | | 62 |
| Beam PF | 104 | 140 | 50 | 90 | 55 | 165 |

As shown in Table 8, the selected Antenna panel 3 is deleted.

After deletion, the beam PF value of <Beam 2, Antenna Panel 1> is the maximum. User 1 is the third scheduled user, and is served by Antenna panel 1 with Beam 2. User 4 is the fourth scheduled user and is served by Antenna panel 1 with Beam 2.

With the above step 3, it is can achieved that overall system performance can be ensured by generating the optimal beam.

Step 4: Frequency-domain and/or time-domain resources allocated to a user are determined according to beam interference detection.

In order to obtain the maximum cell throughput, the system will select frequency-domain and/or time-domain resources (e.g., resource blocks) with the least interference for each user. The embodiment determines the interference situation of users on frequency-domain and/or time-domain resources by beam interference detection.

For a resource block that has been used by a user, serving beams of scheduled users may cause interference on a user newly allocated to the resource block. Therefore, the serving beams of these scheduled users will be added to the interference beam information (e.g., an interference beam list) of the resource block. When a resource is allocated to a new user, if the beam in the active status of the new user coincides with the interference beam list, it is considered that there is an interference (the user interference flag is true, that is, the parameter value of interference parameter information is set to the parameter value indicating that the resource block is interfered). In the case of presence of interference, the user's resource allocation factor (i.e., signal quality information of the interfered resource block) is calculated according to the user's useful signal and total received signal, so as to estimate the throughput (i.e., schedule benefit) obtained by the user when respective resource block groups are allocated, and finally decide the optimal frequency-domain and/or time-domain resource allocated to the user, i.e., determine the start position and number of resource blocks allocated to the user.

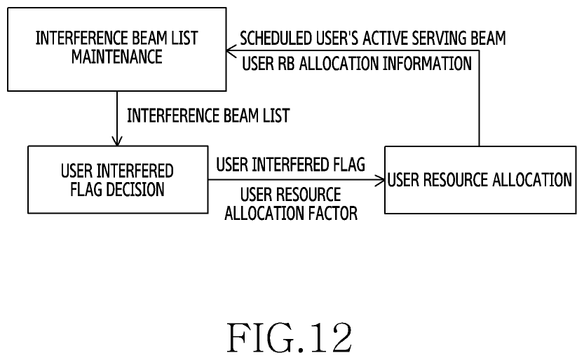

FIG. 12 is main modules affecting interference detection and a flow of their interactions according to an embodiment of the disclosure.

Some terms in FIG. 12 are explained as follows.

Interference beam list of a Resource Block (RB): a set of beams that will interfere with the RB.

User interfered flag: characterizes whether the user is interfered by other scheduled users. The flag is decided according to the beam in the active status of the user and the interference beam list of the resource block of the gNB. The user interfered flag can also be called interference parameter information.

Step 4 is described in detail below.

Step 4-1: The interference beam list of each resource block is decided.

In order to quickly judge the interference situation of a user on a resource block, a corresponding interference beam list is created for each resource block. When a user is scheduled in the resource block (when the user is served by a certain beam and occupies the resource block), the current serving beam of the user is added to the interference beam list of the resource block.

Initially, the interference beam list of each resource block is blank.

After a user is scheduled with a specific<beam, antenna panel> and occupies resource block i, the <beam, antenna panel>information will be added to the interference beam list of the occupied resource block i.

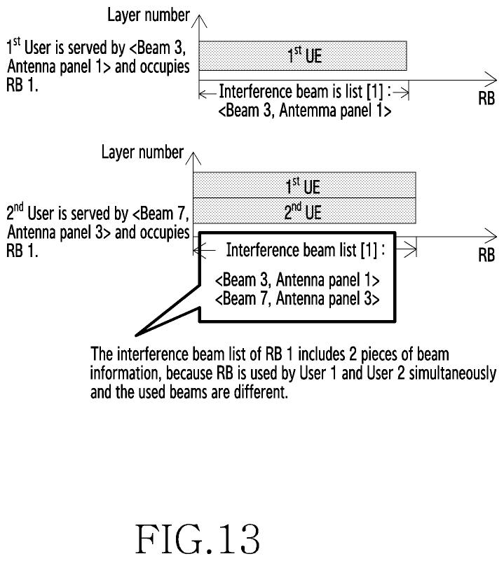

FIG. 13 is a schematic diagram of an interference beam list according to an embodiment of the disclosure.

FIG. 13 shows that the first user is served by <Beam 3, Antenna panel 1> and occupies resource block 1, while the second user is served by <Beam 7, Antenna panel 3> and occupies resource block 1. Therefore, the interference beam list of resource block 1 includes two pieces of beam information: <Beam 3, Antenna panel 1> and <Beam 7, Antenna panel 3>. This is because RB is used by user 1 and user 2 at the same time, and the used beams are different.

Step 4-2: The user interfered flag and the user resource allocation factor are decided.

The user interfered flag is used to indicate whether the user is interfered by another scheduled user using the same RB.

A user interfered flag is decided for each resource block, and the user interfered identifier indicates interference parameter information. For resource block i, if one or more beams among the active serving beams of the user coincide with beams in the interference beam list, the user interfered flag is set as true, otherwise, the user interfered flag is set as false.

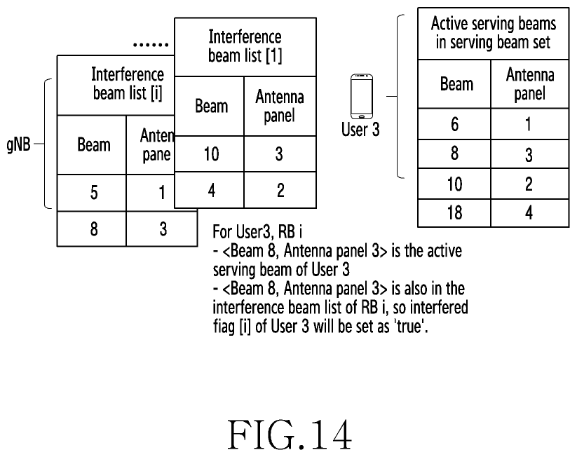

FIG. 14 is a schematic diagram of setting an interference flag according to an embodiment of the disclosure.

FIG. 14 shows that for user 3, resource block i, <Beam 8, Antenna panel 3> is the active serving beam of user 3, and <Beam 8, Antenna panel 3> is also in the interference beam list of RB i, so the interfered flag [i] of user 3 will be set to “true”.

The resource allocation factor on each resource block of the user is decided, and the resource allocation factor can indicate the signal quality information of the interfered resource block. The resource allocation factor is the ratio of the signal receiving power of the serving beam selected by the user to the signal receiving power of all signals received by the user, that is, the ratio of the useful signal power to the total receiving signal power, and is used for indicating the signal quality on the interfered resource block. When useful signal is large and the interference signal is small, the resource allocation factor is large; on the contrary, when useful signal is small and the interference signal is large, the resource allocation factor is small.

For the resource block i, if the interfered flag is true, the resource allocation factor of the user is calculated. The resource allocation factor is calculated according to the following Equation 5:

### Resource Allocation Factor[i]

$$= γ * \frac{RSRP of serving beam selected by user}{\begin{matrix}RSRP of serving beam selected by user + \\ \sum RSRP of beam interference beam list\end{matrix}} \qquad Equation 5$$

where:

γ: calibration parameter, depending on the network environment.

ΣRSRP of beam in interference beam list: characterizes the interference signal power.

Step 4-3: The user's frequency-domain and/or time-domain resources (resource block start position+resource block number) are determined.

Allocating the user on frequency-domain and/or time-domain resources with no interference or less interference can obtain better transmission performance. If there is a completely interference-free resource block group at present, the user will be allocated to the interference-free resource block group that can meet their data transmission requirements. If there is no completely interference-free resource block group, the schedule benefit is calculated based on the resource allocation factor calculated at the previous step. The schedule benefit is used to measure the throughput performance that will be obtained by the whole system when the user is allocated to the resource block group. Therefore, the user will be allocated to the resource block group with the maximum schedule benefit.

Step 4-3-1: Whether there are continuous resource blocks (resource block groups) without interference is determined according to the user interfered flag on the user's resource block.

If the user interfered flag on a certain resource block of a user is false, the resource block can be regarded as a resource block without interference.

Step 4-3-2: Frequency-domain and/or time-domain resources of the user (resource block start position+resource block number) are determined.

If there is a resource block group without interference:

If the number of resource blocks existing in the resource block group is larger than the number of resource blocks required by a user to transmit data, resource block group with the smallest number of resource blocks that can meet the user requirement is selected, which includes:

The start position of the resource block group is taken as the start position of the resource blocks which are allocated to the user.

The number of resource blocks required by the user is taken as the number of resource blocks which are allocated to the user.

If no one of the numbers of resource blocks in the resource block groups is larger than the number of resource blocks required by the user to transmit data, the resource block group with the largest number of resource blocks is selected, which includes:

The start position of the resource block group is taken as the start position of the resource blocks which are allocated to the user.

The number of resource blocks of the resource block group is taken as the number of resource blocks which are allocated to the user.

If there is no resource block group without interference:

The user average resource allocation factor on a resource block group is calculated according to the following Equation 6:

$$User average resource allocation factor = \frac{\begin{matrix}\sum resource allocation \\ factor of user on each resource block i\end{matrix}}{total number of resource blocks} \qquad Equation 6$$

If the user average resource allocation factor on a resource block group is larger than a certain threshold (for example, 0.5), the schedule benefit is calculated according to the average resource allocation factor of the user and the number of resource blocks.

When the user k is allocated to resource block group X, the schedule benefit is calculated according to the following Equations 7 and 8:

Schedule benefit=TBS of all scheduled users on resource block group X+TBS of all scheduled users on other resource block groups+TBS of user k on resource block group X. Equation 7

where TBS of UE on a resource block group=TBS(signal-to-interference-and-noise ratio of user,number of resource blocks of user)*user average resource allocation factor of a resource block group. Equation 8

where TBS represents the Transport Block Size; TBS (signal-to-interference-and-noise ratio of user, number of resource blocks of user) represents calculating TBS based on the signal-to-interference-and-noise ratio of the user and the number of resource blocks of the user.

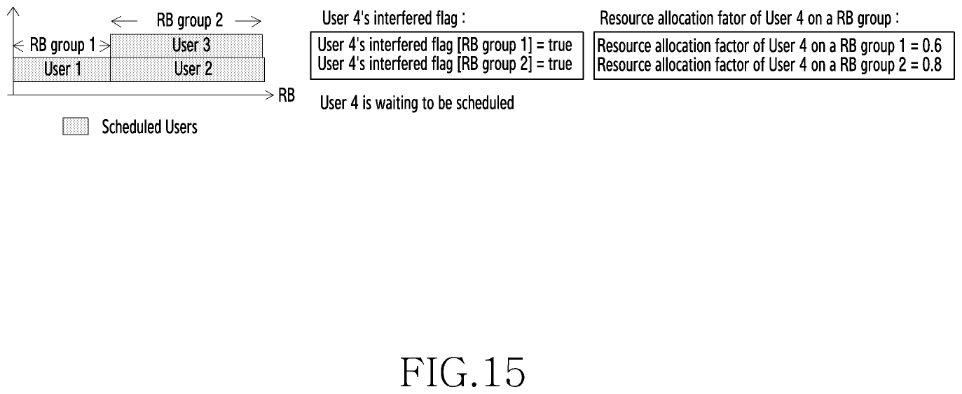

FIG. 15 is a schematic diagram of a UE to be scheduled according to an embodiment of the disclosure.

With the above calculation, the resource block group with the maximum schedule benefit is selected for the user, which includes:

The start position of the resource block group is taken as the start position of the resource blocks which are allocated to the user.

The number of resource blocks of the resource block group is taken as the number of resource blocks which are allocated to the user.

With step 4, the system throughput can be optimized by efficient frequency resource reuse.

Step 5: The cooperative beam set is updated based on precision detection.

Precision detection (which can also be called accuracy detection) is used to detect whether cooperative beam sets of different RSRP ranges of respective beams needs to be updated currently, and they are updated according to the collected information (it can be updated according to period T4 which can be one day), so as to avoid occurrence of serious beam failure caused by insufficient candidate beams in the cooperative beam set.

High-precision cooperative beam set is the prerequisite for users to obtain high-quality serving beam set. In an actual system, due to the change of environment and user distribution, the cooperative beam corresponding to geographical location will also change accordingly. In order to ensure the precision of the cooperative beam set, it is necessary to periodically perform accuracy detection on the cooperative beam set to judge whether the cooperative beam set needs to be updated. When the number of beam failures within a period exceeds a threshold value, it is considered that the cooperative beam set no longer matches the current system environment and needs to be updated.

The specific method of the step is as follows:

The gNB periodically detects the number of beam failures.

When it is checked that the number of beam failures is larger than the threshold, the update of the cooperative beam set is triggered.

The main steps of a precision detection flow are as follows:

1) For the gNB, the number of beam failures is periodically detected:

After the period begins, the number of beam failures is detected every Transmission Time Interval (TTI), and the number of beam failures is accumulated.

2) If it is judged that the accumulated number of beam failures within the period is already larger than the threshold, the update of the cooperative beam set is triggered:

For each period, if the accumulated number of beam failures within the period is greater than the threshold, the update of the cooperative beam set is triggered.

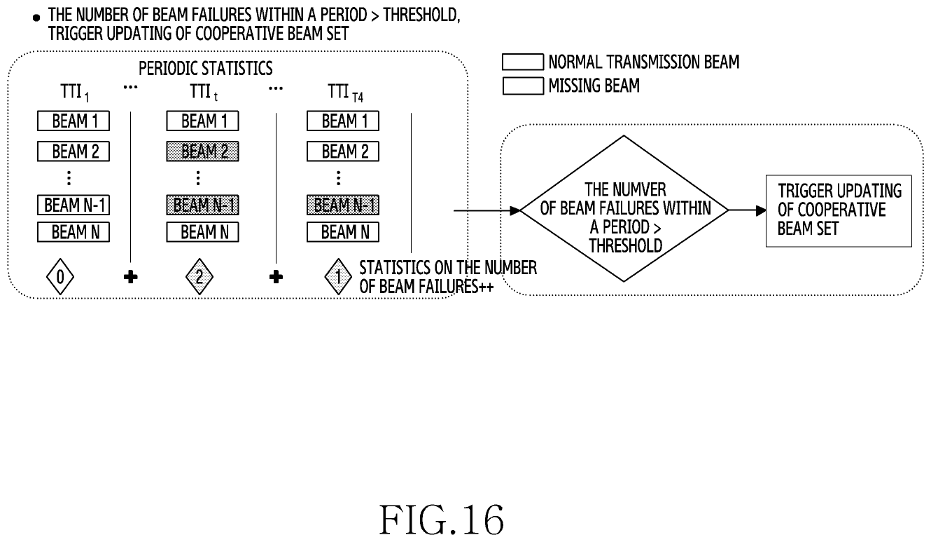

FIG. 16 is a schematic diagram of an accuracy detection flow according to an embodiment of the disclosure.

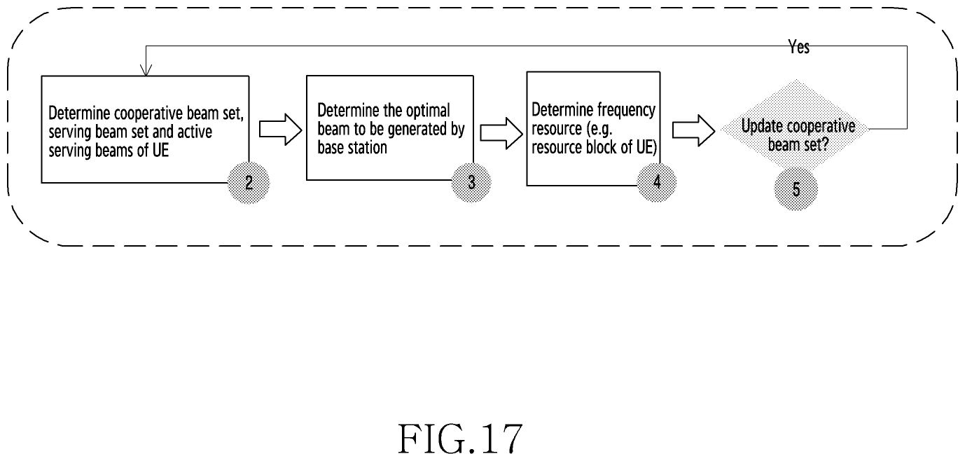

FIG. 17 is a schematic diagram of the position of an accuracy detection step in the overall flow according to an embodiment of the disclosure. In FIG. 17, 5 indicates the accuracy detection step.

With step 5, the precision of the cooperative beam set can be ensured.

Since the system pays more attention to guaranteeing the scheduling opportunities of high Quality of Service (QoS) UEs in some cases, or cannot support complicated beam selection design due to hardware reasons, according to an embodiment of the disclosure, the disclosure also provides step 3a of determining a serving beam to be generated by the gNB according to the order of UE PFs, instead of the above step 3.

In the scheme, the serving beam to be generated is selected according to the order of UE PF values, so as to ensure that a UE with a high PF value can obtain the scheduling right preferentially.

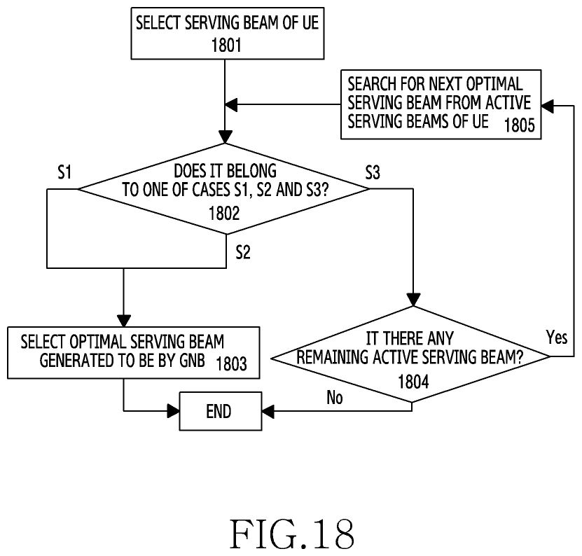

FIG. 18 is a flowchart of determining a serving beam to be generated by gNB according to an embodiment of the disclosure.

Referring to FIG. 18, at operation 1801, the serving beam of the UE is selected, and the operation may be performed as described above. At operation 1802, it is judged whether it belongs to one of cases S1, S2 and S3. Case S1 is that the optimal serving beam of the UE and its associated antenna panel are not used; case S2 is that the optimal beam of the UE and its associated antenna panel have been used by other UEs; and case S3 is that the associated antenna panel of the optimal beam of the UE has served other UEs, but the beams used for these UEs are not the optimal beam of the UE. Specifically, when the serving beam to be generated is selected, if the UE's optimal beam and its associated antenna panel are not used (i.e., case S1), then at operation 1803, the optimal beam is selected as the serving beam to be generated of the gNB, and the UE also performs transmission on the beam. If the optimal beam of the UE has already been used by other UE, and the antenna panel corresponding to the optimal beam also has already been used by the other UE (i.e., case S2), then at operation 1803, the UE may also perform transmission on the beam. If the associated antenna panel of the optimal beam of the UE has already served other UEs (i.e., case S3), then at operation 1804, it is judged whether there are remaining active serving beams. If there are, at operation 1805, the next sub-optimal serving beam is searched for from the remaining active serving beams of the UE, and it returns to operation 1802 to judge whether it belongs to one of cases S1, S2 and S3. If there is no selectable beam among the active serving beams of the UE, the method is ended.

Step 3a-1: UEs are sorted according to PF.

The PF value of each terminal is calculated, and the terminals are sorted according to the descending order of PF values of UEs.

Step 3a-2: the serving beam to be generated by the gNB is determined according to the beam selected by the UE.

According to the ranking of PF values of UEs, its serving beam is selected.

The serving beam is generated by the beam of the selected UE, and each panel can generate only one serving beam at the same time.

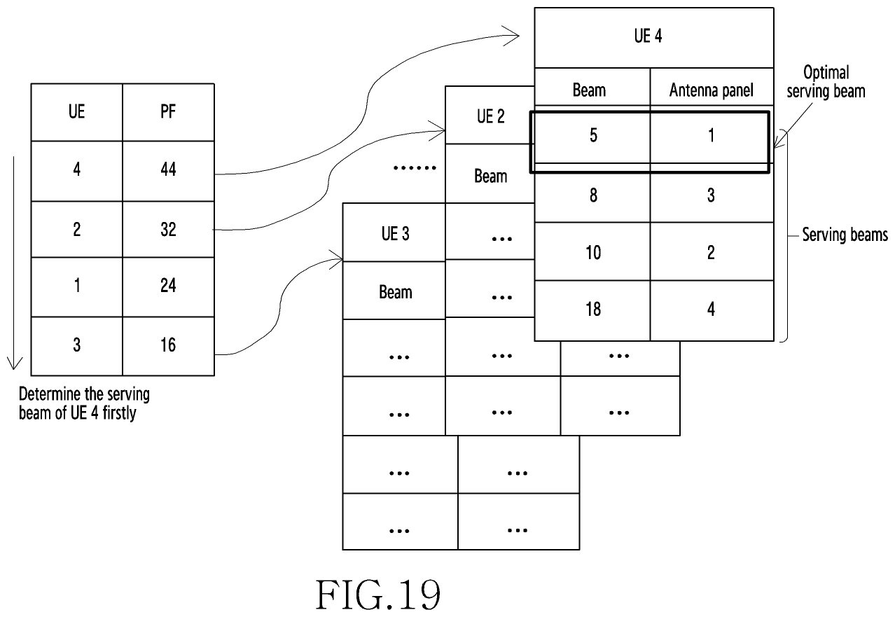

FIG. 19 shows a schematic diagram of determining a serving beam to be generated by gNB according to an embodiment of the disclosure, in which it is showed that UE4 is selected by sorting the UEs according to their PF values at first, and then the serving beam of UE4 is determined among the active serving beams of UE4.

There are three cases in step 3a-2:

Scenario S1: The optimal beam of the UE and its associated antenna panel are not used, and then it is selected as the serving beam to be generated by the gNB.

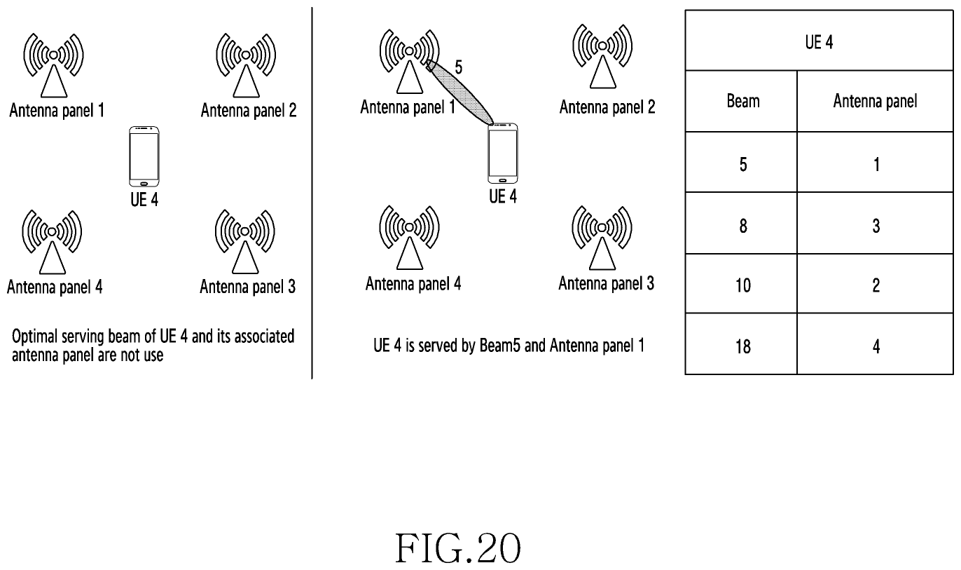

FIG. 20 shows a schematic diagram of case S1 according to an embodiment of the disclosure.

For example, because the optimal beam of UE4 and its associated antenna panel are not used, UE4 is served by Beam 5 and Antenna panel 1.

Scenario S2: The optimal beam of the UE and its associated antenna panel have been used by other UEs, and it is selected as the serving beam to be generated by the gNB.

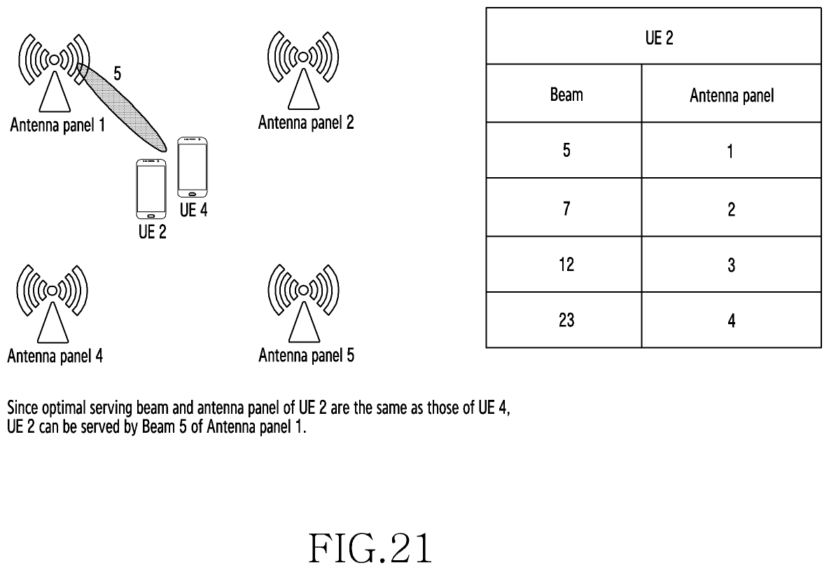

FIG. 21 shows a schematic diagram of case S2 according to an embodiment of the disclosure.

For example, since the optimal beam and antenna panel of UE2 are the same as those of UE4, UE2 can be served by Beam 5 of Antenna panel 1.

Scenario S3: The associated antenna panel of the optimal beam of the UE has served other UEs, but the beams used for these UEs are not the optimal beam of the UE, then it is checked whether there is a next serving beam available among the remaining active serving beams.

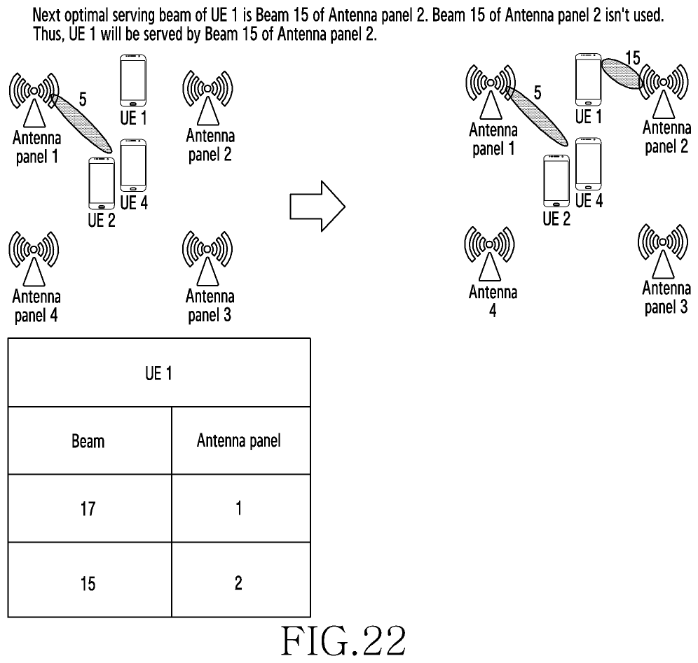

FIG. 22 shows a schematic diagram of case S3 according to an embodiment of the disclosure.

In case S3, the following two steps may be further included.

Step 3a-2-S3-1: The optimal beam of UE1 and its antenna panel are checked.

For example, the current optimal beam of UE1 is Beam 17 of Antenna panel 1, but Beam 5 of Antenna panel 1 is used to serve UE4 and UE2, so Antenna panel 1 cannot serve UE1.

Step 3a-2-S3-2: It is checked whether there is a next serving beam available for UE1 among the remaining active serving beams.

The next optimal beam of UE1 is Beam 15 of Antenna panel 2, and Beam 15 of Antenna panel 2 is not used, so UE1 will be served by Beam 15 of Antenna panel 2.

According to an embodiment of the disclosure, the disclosure also provides step 3b instead of the above step 3.

Step 3b-1: The PF value of each user under each active serving beam is calculated.

The user's active serving beam is selected from the user's serving beam set, and the active serving beam has been decided by step 2.

The PF value of the user under each active serving beam is decided by the following Equation 9:

$$PF of user under one beam = \frac{{( {R}_{i} ( t ) )}^{α}}{{( \overline{( {R}_{i} ( t ) )} )}^{β}} \qquad Equation 9$$

Rᵢ(t) is the data rate of user i at the current time t, and (̅R̅ᵢ̅(̅t̅)̅)̅ is the average throughput of user i. α is the weight of efficiency and β is the weight of fairness.

And all users in the beam are sorted in descending order according to their PF values.

Step 3b-2: The beam with the maximum beam PF value is selected as the serving beam to be generated of the corresponding antenna panel.

Deciding the serving beam to be generated by the antenna panel includes:

calculating the beam PF values of all selectable beams according to the following Equation 10.

$$Beam PF value : {BM}_{k} = \frac{{( {R}_{k} ( t ) )}^{α}}{{( \overline{( {R}_{k} ( t ) )} )}^{β}} = \frac{{( {Σ}_{i ∈ ( 1 , … , Q )} {R}_{i} ( t ) )}^{α}}{{( \frac{{Σ}_{i ∈ ( 1 , … , Q )} {R}_{l} ( t )}{Q} )}^{β}} , \qquad Equation 10$$

Rₖ(t) is the total data rate of schedulable users at the current time t of beam k, (̅R̅ₖ̅(̅t̅)̅)̅ is the average throughput of schedulable users in beam k. Rᵢ(t) is the data rate of user i at the current time t, and (̅R̅ᵢ̅(̅t̅)̅)̅ is the average throughput of user i. α is the weight of efficiency and β is the weight of fairness. Due to frequency-domain and/or time-domain resources being limited, when the resources required by a user exceed the scheduling capability of beams, the remaining users with low PF values will not be scheduled. Only users that can be scheduled are considered when calculating the PF value, and Equation 10 should satisfy the constraints of the following Equation 11:

Q≤P,Σ_{i∈(1, . . . ,Q-1)}BOᵢ<BOₜₕ Equation 11

P is the number of all users under the beam, and Q is the maximum number of users that can be scheduled by the beam. The threshold value BOₜₕ of data cache size is used to limit the number of users that can be scheduled by the beam, and BOₜₕ is the Transport Block Size (TBS) value estimated according to the number of RBs and MCS. BOᵢ is the current cache size of user i.

According to an embodiment of the application, the specific procedure of calculating PF values for all selectable beams is as follows:

Step 3b-2-1: Select the first beam k among N beams, where k=1.

Step 3b-2-2: Initialize Rₖ(t)=0, R̅ₖ̅(̅t̅)̅=0, SumBO=0 and Q=0.

Step 3b-2-3: Sort all candidate users in beam k in descending order according to PF values of users under the beam to generate a user queue. Select the first user i in the queue, where i=1.

Step 3b-2-4: If SumBO<BOₜₕ, then SumBO=SumBO+BOᵢ, calculate the total data rate of the user Rₖ(t)=Rₖ(t)+Rᵢ(t), R̅ₖ̅(̅t̅)̅=R̅ₖ̅(̅t̅)̅+R̅ᵢ̅(̅t̅)̅, Q=Q+1, i=i+1, and jump to the next step 3b-2-5. If SumBO≥BOₜₕ, jump to step 3b-2-6.

Step 3b-2-5: If i≤P, jump to step 3b-2-4, otherwise, jump to step 3b-2-6.

Step 3b-2-6: Calculate the average throughput of Q candidate users under beam k R̅ₖ̅(̅t̅)̅=R̅ₖ̅(̅t̅)̅/Q, and calculate the PF of beam k, PF of beam

$$k = \frac{{( {R}_{k} ( t ) )}^{α}}{{( \overline{{R}_{k} ( t )} )}^{β}} ,$$

k=k+1.

Step 3b-2-7: If k≤N, jump to step 3b-2-2, otherwise, calculation of PF values of all beams has been finished.

All selectable beams are arranged in descending order according to PF values, and the beam with the maximum beam PF value is selected as the serving beam to be generated of the corresponding antenna panel.

In addition, according to an embodiment of the application, deciding to schedule a user includes: if the active serving beam of the user is the same as the selected serving beam to be generated, the user will be scheduled. And, it is deleted from the candidate user queue. The scheduling order of users under the same serving beam to be generated is decided according to the descending order of the PF values of users under the beam.

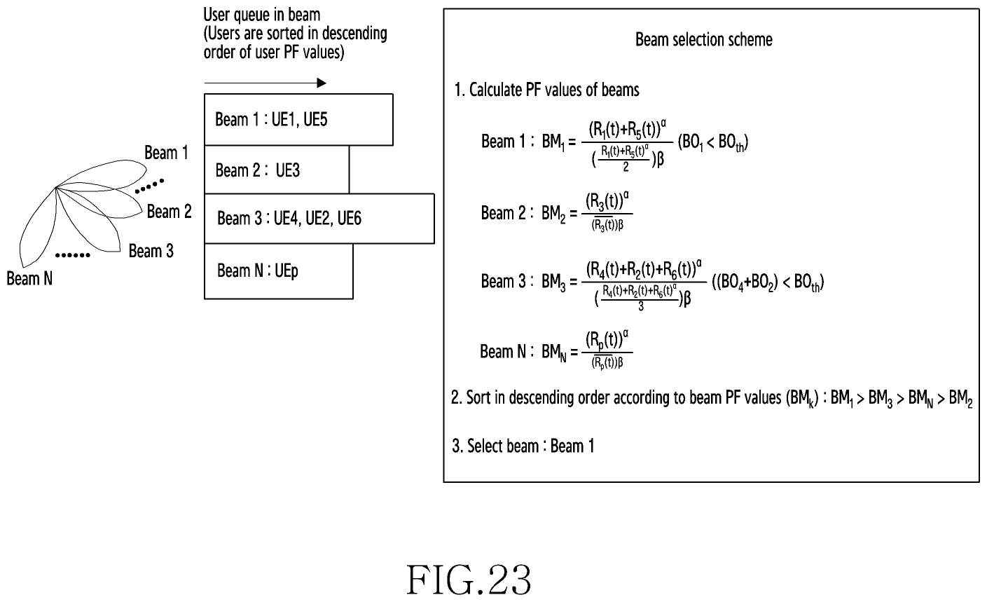

FIG. 23 is a schematic diagram of beam selection according to an embodiment of the disclosure.

Referring to FIG. 23, Beams 1-N are selectable beams (active serving beams), and every two adjacent beams are located in an antenna panel, for example, Beam 1 and Beam 2 are in Antenna panel 1. The users in each beam are arranged in descending order of the PF values of the users under the beam. According to step 3b-2-1 to step 3b-2-6, the PF value BMₖ of each beam can be calculated, and BM₁>BM₃>BM_{N}>BM₂> . . . . <Beam 1, Antenna panel 1>has the maximum PF value, and user 1 in the beam has the maximum user PF value, so user 1 will be the first to be served by Antenna panel 1 with Beam 1. User 5 will be the second to be served by Antenna panel 1 with Beam 1. Once a user is scheduled, the user is deleted.

Step 3b-3: An antenna panel that has generated a beam is deleted, a beam that has been generated by other antenna panels is deleted, and the operation of the first two steps is looped until each antenna panel has generated a beam or there is no unscheduled user.

The disclosure can be implemented and deployed in any suitable part of the base station, for example, in Medium Access Control (MAC) module of gNB Distributed Unit (DU), but the application is not limited thereto.

For example, the algorithm of the disclosure (including an optional AI module) can be implemented in the MAC module in the DU of gNB equipment.

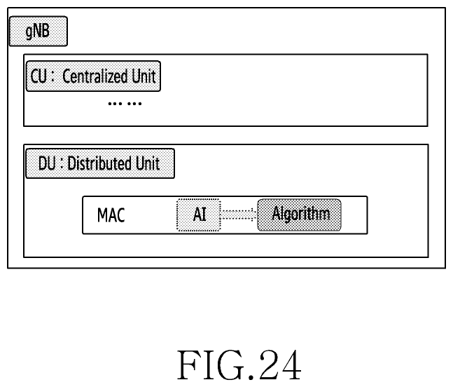

FIG. 24 shows a block diagram of the MAC module in the DU of gNB equipment according to an embodiment of the disclosure, which may include:

a module for determining cooperative beam sets of respective beams under different RSRP ranges at period T1 (for example, 1 week);

a module for determining the serving beam set of the UE at period T2 (1 second);

a module for determining the active serving beams of the UE at period T3 (e.g., 100 milliseconds);

a module for determining the real-time beam generated by the gNB at each time slot;

a module for determining real-time frequency-domain and/or time-domain resources (e.g., resource block RB) of the UE at each time slot;

a module for updating the cooperative beam set based on precision detection at period T4 (for example, 1 day or several days).

In addition, the embodiment of the disclosure is not limited to the MAC module in the DU of gNB equipment, but may be any suitable apparatus in the gNB, and the apparatus may include various modules for implementing the method of the disclosure.

In addition, a base station (e.g., gNB) according to an embodiment of the disclosure may include one or more processors and a memory. One or more processes may load and execute instructions stored in the memory. The memory may store one or more instructions which, when executed by the one or more processors, implement various methods and/or steps according to embodiments of the disclosure.

An apparatus according to an embodiment of the disclosure may include multiple units. At least one of the multiple units can be implemented by an AI model. The functions related to AI can be performed by a nonvolatile memory, a volatile memory and a processor.

The processor may include one or more processors. At this time, one or more processors may be general-purpose processors, such as a central processing unit (CPU), an application processor (AP), or similar pure graphics processing units, such as a graphics processing unit (GPU), a visual processing unit (VPU), and/or an artificial intelligence dedicated processor, such as a neural processing unit (NPU).

One or more processors control the processing of input data according to a predefined operating rule or an artificial intelligence (AI) model stored in a nonvolatile memory and a volatile memory. The predefined operation rule or artificial intelligence model is provided through training or learning.

Here, providing by learning means applying a learning algorithm to multiple learning data to make a predefined operation rule or an expected feature of an artificial intelligence model. The learning can be performed on the device in which the AI model according to the embodiment is executed, and can be implemented by a separate server/system.

The AI model can include multiple neural network layers. Each layer has multiple weight values, and layer operations are performed by the operation of calculating the previous layer and multiple weights. Examples of neural networks include, but are not limited to, convolutional neural networks (CNN), deep neural networks (DNN), recurrent neural networks (RNNN), restricted Boltzmann machines (RBM), deep belief networks (DBN), bidirectional recursive deep neural networks (BRDNN), generated antagonistic networks (GAN) and deep Q networks.

Learning algorithm is a method of training a predetermined target device (for example, a robot) by using complex learning data, so as to cause, allow or control the target device to make judgments or predictions. Examples of learning algorithms include, but are not limited to, supervised learning, unsupervised learning, semi-supervised learning, semi-supervised learning or reinforcement learning.

Simulation is performed for the method of the embodiment of the disclosure, in which an A6G centralized MIMO and an A6G distributed MIMO are compared.

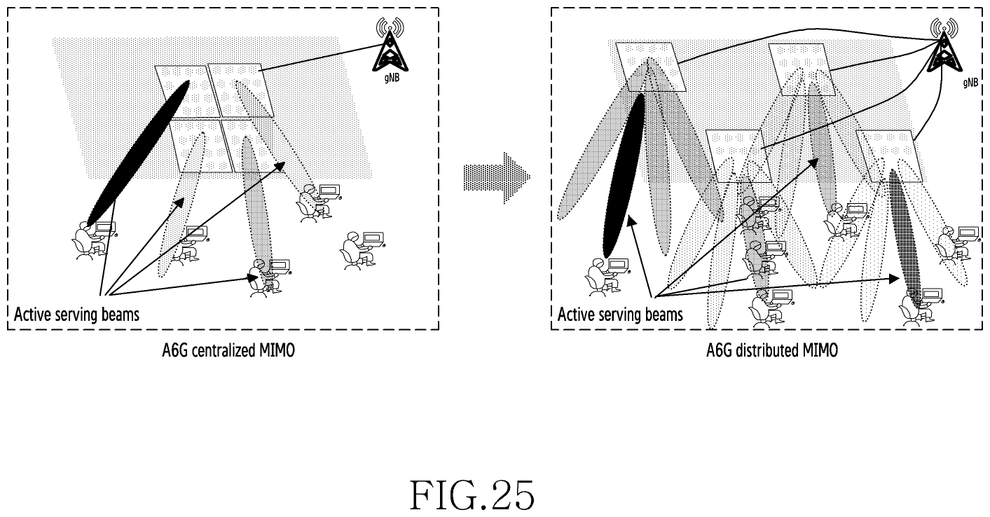

FIG. 25 shows a schematic diagram of an A6G centralized MIMO and an A6G distributed MIMO according to an embodiment of the disclosure.

Simulation results show that for the A6G distributed MIMO, due to intelligent beam selection and frequency resource reuse, UEs can be sufficiently scheduled and the frequency resource reuse is improved.

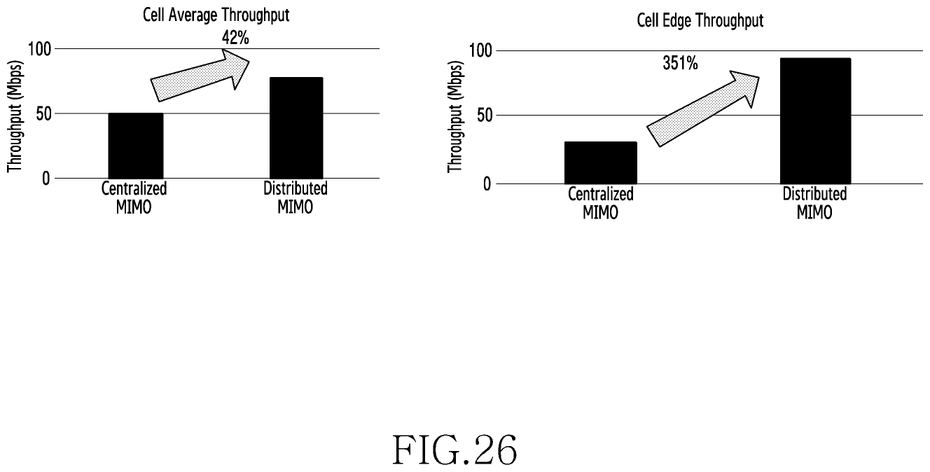

FIG. 26 shows a simulation result according to an embodiment of the disclosure. Specifically, comparing the A6G centralized MIMO with the A6G distributed MIMO, the average uplink throughput of the cell is increased by 42%, and the uplink throughput of the cell edge is increased by 351%. The specific reasons are analyzed exemplarily as follows:

1) Because the antenna panels are uniformly distributed within an area, UEs within the cell (especially edge UEs) can be served more effectively;

2) Most UEs can be covered by at least two beams, so that UEs can be sufficiently scheduled, and the reuse of frequency resources is increased, so the system throughput is obviously increased.

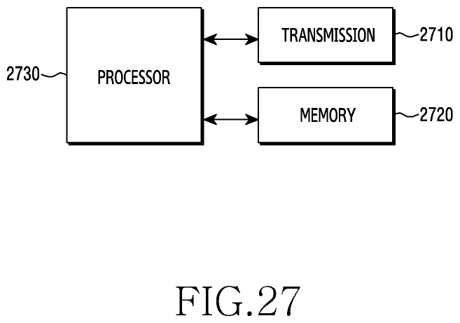

FIG. 27 illustrates a block diagram illustrating a structure of a UE according to an embodiment of the disclosure.

Referring to FIG. 27, the UE according to an embodiment may include a transceiver 2710, a memory 2720, and a processor 2730. The transceiver 2710, the memory 2720, and the processor 2730 of the UE may operate according to a communication method of the UE described above. However, the components of the UE are not limited thereto. For example, the UE may include more or fewer components than those described above. In addition, the processor 2730, the transceiver 2710, and the memory 2720 may be implemented as a single chip. Also, the processor 2730 may include at least one processor.

The transceiver 2710 collectively refers to a UE receiver and a UE transmitter, and may transmit/receive a signal to/from a base station or a network entity. The signal transmitted or received to or from the base station or a network entity may include control information and data. The transceiver 2710 may include a RF transmitter for up-converting and amplifying a frequency of a transmitted signal, and a RF receiver for amplifying low-noise and down-converting a frequency of a received signal. However, this is only an example of the transceiver 2710 and components of the transceiver 2710 are not limited to the RF transmitter and the RF receiver.

Also, the transceiver 2710 may receive and output, to the processor 2730, a signal through a wireless channel, and transmit a signal output from the processor 2730 through the wireless channel.

The memory 2720 may store a program and data required for operations of the UE. Also, the memory 2720 may store control information or data included in a signal obtained by the UE. The memory 2720 may be a storage medium, such as read-only memory (ROM), random access memory (RAM), a hard disk, a compact disc (CD)-ROM, and a digital versatile disc (DVD), or a combination of storage media.

The processor 2730 may control a series of processes such that the UE operates as described above. For example, the transceiver 2710 may receive a data signal including a control signal transmitted by the base station or the network entity, and the processor 2730 may determine a result of receiving the control signal and the data signal transmitted by the base station or the network entity.

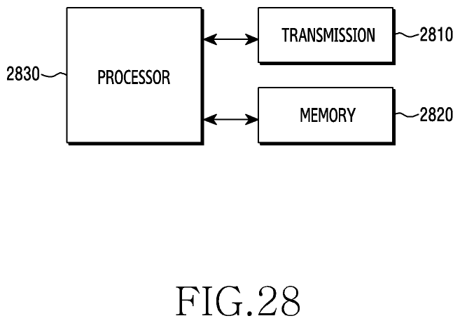

FIG. 28 illustrates a block diagram illustrating a structure of a base station according to an embodiment of the disclosure.

Referring to FIG. 28, the base station according to an embodiment may include a transceiver 2810, a memory 2820, and a processor 2830. The transceiver 2810, the memory 2820, and the processor 2830 of the base station may operate according to a communication method of the base station described above. However, the components of the base station are not limited thereto. For example, the base station may include more or fewer components than those described above. In addition, the processor 2830, the transceiver 2810, and the memory 2820 may be implemented as a single chip. Also, the processor 2830 may include at least one processor.

The transceiver 2810 collectively refers to a base station receiver and a base station transmitter, and may transmit/receive a signal to/from a terminal or a network entity. The signal transmitted or received to or from the terminal or a network entity may include control information and data. The transceiver 2810 may include a RF transmitter for up-converting and amplifying a frequency of a transmitted signal, and a RF receiver for amplifying low-noise and down-converting a frequency of a received signal. However, this is only an example of the transceiver 2810 and components of the transceiver 2810 are not limited to the RF transmitter and the RF receiver.

Also, the transceiver 2810 may receive and output, to the processor 2830, a signal through a wireless channel, and transmit a signal output from the processor 2830 through the wireless channel.

The memory 2820 may store a program and data required for operations of the base station. Also, the memory 2820 may store control information or data included in a signal obtained by the base station. The memory 2820 may be a storage medium, such as read-only memory (ROM), random access memory (RAM), a hard disk, a CD-ROM, and a DVD, or a combination of storage media.

The processor 2830 may control a series of processes such that the base station operates as described above. For example, the transceiver 2810 may receive a data signal including a control signal transmitted by the terminal, and the processor 2830 may determine a result of receiving the control signal and the data signal transmitted by the terminal.

According to various embodiments, a method for beam selection, the method comprising: acquiring at least one of network related information or user equipment (UE) related information for the beam selection; determining at least one first candidate beam corresponding to the UE among beams of a base station based on the at least one of network related information or UE related information; and determining a serving beam of the UE based on the determined at least one first candidate beam.

In one embodiment, wherein the network related information comprises at least one of: a number of beam failures in respective beams, a relationship between a beam and an antenna panel, status information of respective frequency-domain, or time-domain resources in a beam scheduling procedure.

In one embodiment, wherein the UE related information for the beam selection comprises at least one of: reference signal receiving power (RSRP) information of the beam reported by the UE, negative acknowledgement (NACK) information reported by the UE, or proportional fairness (PF) values corresponding to the UE.

In one embodiment, wherein the determining of the at least one first candidate beam corresponding to the UE among the beams of the base station based on the at least one of network related information or UE related information comprises: among respective beams of the base station, determining a second candidate beam of the UE based on the at least one of network related information or UE related information; among respective cooperative beam sets corresponding to the second candidate beam, determining a cooperative beam set corresponding to the UE based on the at least one of network related information or UE related information, wherein the cooperative beam set contains at least one cooperative beam corresponding to the second candidate beam; and among the second candidate beam and the determined cooperative beam set, determining the at least one first candidate beam corresponding to the UE.

In one embodiment, the method further comprising: for respective beams of the base station, determining cooperative beam sets of the beams corresponding to respective reference signal receiving power (RSRP) ranges based on RSRP information of beams reported by respective UEs within a pre-set time period respectively.

In one embodiment, wherein the determining of the cooperative beam sets of the beams corresponding to the respective RSRP ranges comprises: determining a candidate cooperative beam set corresponding to respective RSRP values of the beam; grouping the RSRP values into different RSRP ranges; and constituting a cooperative beam set corresponding to the RSRP range with beams in candidate cooperative beam sets corresponding to respective RSRP values belonging to the same RSRP range.

In one embodiment, wherein the determining of the candidate cooperative beam set corresponding to the respective RSRP values of the beam comprises: determining the UE with the largest RSRP value for the beam; and for each UE determined, based on the RSRP values of other beams fed back by the UE, selecting a first set number of third candidate beams from the other beams, and taking the beam and the selected first set number of third candidate beams as the candidate cooperative beam set corresponding to the largest RSRP value of the UE.

According to various embodiments, an electronic device for beam selection, the electronic device comprising: at least one transceiver; at least one processor operably coupled to the at least one transceiver; and a memory for storing computer program instructions, wherein the at least one processor is configured to: acquire at least one of network related information or user equipment (UE) related information for the beam selection, determine at least one first candidate beam corresponding to the UE among beams of a base station based on the at least one of network related information or UE related information, and determine a serving beam of the UE based on the determined at least one first candidate beam.

In one embodiment, wherein the network related information comprises at least one of: a number of beam failures in respective beams, a relationship between a beam and an antenna panel, status information of respective frequency-domain, or time-domain resources in a beam scheduling procedure.

In one embodiment, wherein the UE related information for the beam selection comprises at least one of: reference signal receiving power (RSRP) information of the beam reported by the UE, negative acknowledgement (NACK) information reported by the UE, or proportional fairness (PF) values corresponding to the UE.

In one embodiment, in order to determine of the at least one first candidate beam corresponding to the UE among the beams of the base station based on the at least one of network related information or UE related information, wherein the at least one processor is configured to: among respective beams of the base station, determine a second candidate beam of the UE based on the at least one of network related information or UE related information; among respective cooperative beam sets corresponding to the second candidate beam, determine a cooperative beam set corresponding to the UE based on the at least one of network related information or UE related information, wherein the cooperative beam set contains at least one cooperative beam corresponding to the second candidate beam; and among the second candidate beam and the determined cooperative beam set, determine the at least one first candidate beam corresponding to the UE.

In one embodiment, wherein the at least one processor is further configured to: for respective beams of the base station, determine cooperative beam sets of the beams corresponding to respective reference signal receiving power (RSRP) ranges based on RSRP information of beams reported by respective UEs within a pre-set time period respectively.

In one embodiment, in order to determine of the cooperative beam sets of the beams corresponding to the respective RSRP ranges, wherein the at least one processor is configured to: determine a candidate cooperative beam set corresponding to respective RSRP values of the beam; group the RSRP values into different RSRP ranges; and constitute a cooperative beam set corresponding to the RSRP range with beams in candidate cooperative beam sets corresponding to respective RSRP values belonging to the same RSRP range.

In one embodiment, in order to determine of the candidate cooperative beam set corresponding to the respective RSRP values of the beam, wherein the at least one processor is configured to: determine the UE with the largest RSRP value for the beam; and for each UE determined, based on the RSRP values of other beams fed back by the UE, select a first set number of third candidate beams from the other beams, and take the beam and the selected first set number of third candidate beams as the candidate cooperative beam set corresponding to the largest RSRP value of the UE.

Those ordinary skills in the art may realize that the units and algorithm steps of each example described in combination with the embodiments disclosed herein can be implemented by electronic hardware or a combination of computer software and electronic hardware. Whether these functions are performed by hardware or software depends on the specific applications and design constraints of the technical schemes. Professional technicians can use different methods for each specific application to implement the described functions, but such implementation should not be considered as going beyond the scope of the disclosure.

The above describes the basic principles of the disclosure in conjunction with specific embodiments. However, it should be pointed out that the advantages, benefits, effects, etc. mentioned in the disclosure are only examples and not limitations. These advantages, benefits, effects, etc. cannot be considered as necessary for each embodiment of the disclosure. In addition, the specific details disclosed in the above are only for the purposes of illustration and easy to understand, rather than limitations, and the foregoing details do not limit the disclosure to that the foregoing specific details for implementation are necessary.

The block diagrams of the devices, apparatuses, equipment and systems involved in the disclosure are merely illustrative examples and are not intended to require or imply that they must be connected, arranged and configured in the manner shown in the block diagrams. As will be recognized by those skilled in the art, these devices, apparatuses, equipment and systems can be connected, arranged and configured in any manner. Words such as “include”, “contain”, “have”, etc. are open vocabulary and mean “including but not being limited to” and can be used interchangeably therewith. The terms “or” and “and” as used here refer to the term “and/or” and can be used interchangeably therewith, unless the context clearly indicates otherwise. The term “such as” as used here refers to the phrase “such as but not limited to” and can be used interchangeably therewith.

It should also be pointed out that, in the system and method of the disclosure, each component or each step can be decomposed and/or recombined. Such decomposition and/or recombination should be regarded as equivalent solutions of the disclosure.

Various changes, substitutions and alterations to the technology described herein can be made without departing from the technology of the teaching defined by the appended claims. In addition, the scope of the claims of the disclosure is not limited to the specific aspects of the processing, machines, manufacturing, composition of event, means, methods and actions described above. The processing, machines, manufacturing, composition of event, means, method or action currently existing or to be developed later, which perform substantially the same functions or achieve substantially the same results as the corresponding aspects described herein, can be utilized. Therefore, the appended claims include such processing, machine, manufacturing, composition of event, means, methods or actions within its scope.

While the disclosure has been shown and described with reference to various embodiments thereof, it will be understood by those skilled in the art that various changes in form and details may be made therein without departing from the spirit and scope of the disclosure as defined by the appended claims and their equivalents.

What is claimed is:

1. A method for beam selection, the method comprising:
acquiring at least one of network related information or user equipment (UE) related information for the beam selection;
determining at least one first candidate beam corresponding to the UE among beams of a base station based on the at least one of network related information or UE related information; and
determining a serving beam of the UE based on the determined at least one first candidate beam.

2. The method of the claim 1, wherein the network related information comprises at least one of:
a number of beam failures in respective beams,
a relationship between a beam and an antenna panel,
status information of respective frequency-domain, or
time-domain resources in a beam scheduling procedure.

3. The method of the claim 1, wherein the UE related information for the beam selection comprises at least one of:
reference signal receiving power (RSRP) information of the beam reported by the UE,
negative acknowledgement (NACK) information reported by the UE, or
proportional fairness (PF) values corresponding to the UE.

4. The method of the claim 1, wherein the determining of the at least one first candidate beam corresponding to the UE among the beams of the base station based on the at least one of network related information or UE related information comprises:
among respective beams of the base station, determining a second candidate beam of the UE based on the at least one of network related information or UE related information;
among respective cooperative beam sets corresponding to the second candidate beam, determining a cooperative beam set corresponding to the UE based on the at least one of network related information or UE related information, wherein the cooperative beam set contains at least one cooperative beam corresponding to the second candidate beam; and
among the second candidate beam and the determined cooperative beam set, determining the at least one first candidate beam corresponding to the UE.

5. The method of the claim 4, further comprising:
for respective beams of the base station, determining cooperative beam sets of the beams corresponding to respective reference signal receiving power (RSRP) ranges based on RSRP information of beams reported by respective UEs within a pre-set time period respectively.

6. The method of the claim 5, wherein the determining of the cooperative beam sets of the beams corresponding to the respective RSRP ranges comprises:
determining a candidate cooperative beam set corresponding to respective RSRP values of the beam;
grouping the RSRP values into different RSRP ranges; and
constituting a cooperative beam set corresponding to the RSRP range with beams in candidate cooperative beam sets corresponding to respective RSRP values belonging to the same RSRP range.

7. The method of the claim 6, wherein the determining of the candidate cooperative beam set corresponding to the respective RSRP values of the beam comprises:
determining the UE with the largest RSRP value for the beam; and
for each UE determined, based on the RSRP values of other beams fed back by the UE, selecting a first set number of third candidate beams from the other beams, and taking the beam and the selected first set number of third candidate beams as the candidate cooperative beam set corresponding to the largest RSRP value of the UE.

8. An electronic device for beam selection, the electronic device comprising:
at least one transceiver;
at least one processor operably coupled to the at least one transceiver; and
a memory for storing computer program instructions,
wherein the at least one processor is configured to:
acquire at least one of network related information or user equipment (UE) related information for the beam selection,
determine at least one first candidate beam corresponding to the UE among beams of a base station based on the at least one of network related information or UE related information, and
determine a serving beam of the UE based on the determined at least one first candidate beam.

9. The electronic device of the claim 8, wherein the network related information comprises at least one of:
a number of beam failures in respective beams,
a relationship between a beam and an antenna panel,
status information of respective frequency-domain, or
time-domain resources in a beam scheduling procedure.

10. The electronic device of the claim 8, wherein the UE related information for the beam selection comprises at least one of:
reference signal receiving power (RSRP) information of the beam reported by the UE,
negative acknowledgement (NACK) information reported by the UE, or
proportional fairness (PF) values corresponding to the UE.

11. The electronic device of the claim 8, in order to determine of the at least one first candidate beam corresponding to the UE among the beams of the base station based on the at least one of network related information or UE related information, wherein the at least one processor is configured to:
among respective beams of the base station, determine a second candidate beam of the UE based on the at least one of network related information or UE related information;
among respective cooperative beam sets corresponding to the second candidate beam, determine a cooperative beam set corresponding to the UE based on the at least one of network related information or UE related information, wherein the cooperative beam set contains at least one cooperative beam corresponding to the second candidate beam; and
among the second candidate beam and the determined cooperative beam set, determine the at least one first candidate beam corresponding to the UE.

12. The electronic device of the claim 11, wherein the at least one processor is further configured to:
for respective beams of the base station, determine cooperative beam sets of the beams corresponding to respective reference signal receiving power (RSRP) ranges based on RSRP information of beams reported by respective UEs within a pre-set time period respectively.

13. The electronic device of the claim 12, in order to determine of the cooperative beam sets of the beams corresponding to the respective RSRP ranges, wherein the at least one processor is configured to:
determine a candidate cooperative beam set corresponding to respective RSRP values of the beam;
group the RSRP values into different RSRP ranges; and
constitute a cooperative beam set corresponding to the RSRP range with beams in candidate cooperative beam sets corresponding to respective RSRP values belonging to the same RSRP range.

14. The electronic device of the claim 13, in order to determine of the candidate cooperative beam set corresponding to the respective RSRP values of the beam, wherein the at least one processor is configured to:
determine the UE with the largest RSRP value for the beam; and
for each UE determined, based on the RSRP values of other beams fed back by the UE, select a first set number of third candidate beams from the other beams, and take the beam and the selected first set number of third candidate beams as the candidate cooperative beam set corresponding to the largest RSRP value of the UE.
